(19) United States
(12) Patent Application Publication
(10) Pub. No.: US 2026/0289447 A1
(43) Pub. Date: Sep. 24, 2026

(54) SYSTEM

(71) Applicant: SoftBank Group Corp., Tokyo (JP)

(72) Inventor: Han Yang SHEN, Tokyo (JP)

(73) Assignee: SoftBank Group Corp., Tokyo (JP)

(21) Appl. No.: 19/567,316

(22) Filed: Mar. 16, 2026

(30) Foreign Application Priority Data
Mar. 19, 2025 (JP) 2025-045166

(51) Int. Cl. G06Q 10/0631; G10L 25/30; G10L 25/63

(52) U.S. Cl. CPC G06Q 10/063116; G10L 25/30; G10L 25/63

(57) ABSTRACT

A system includes a processor that is configured to obtain, by using a generative artificial intelligence model, self-evaluation information of an employee and work plan information of the employee, analyze the obtained information and organize project information, work time information, and characteristic information of the employee, identify an emotional state of the employee by using an emotion analysis engine, and adjust an evaluation result for the employee based on the identified emotional state.

### CROSS-REFERENCE TO RELATED APPLICATION

This application is based on and claims priority under 35 USC 119 from Japanese Patent Application No. 2025-045166 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional employee performance evaluation systems rely heavily on manual input and subjective judgment by managers and human resources personnel. In many cases, self-evaluation information provided by employees and work plan information, such as calendar entries or project schedules, are not effectively integrated or analyzed in a structured manner. As a result, it is difficult to obtain an accurate and comprehensive view of an employee's work efficiency and performance.

Furthermore, existing systems typically do not consider the emotional state of the employee at the time of self-evaluation. When the emotional state of the employee is ignored, the self-evaluation may be biased either positively or negatively, which can lead to distortions in the final evaluation result. This lack of emotional context reduces fairness and reliability of the evaluation.

In addition, because much of the evaluation work is performed manually without sophisticated automation, the evaluation process requires significant time and effort from managers and human resources personnel. This leads to increased operational costs and limits the frequency and granularity of evaluations that can realistically be performed. There is therefore a need for a system that can automatically acquire and analyze self-evaluation information and work plan information, incorporate emotional analysis of the employee, and produce adjusted evaluation results, thereby reducing the time required for evaluation and improving the comprehensiveness and efficiency of work efficiency evaluations.

### SUMMARY

In order to solve the above-described problems, according to one aspect, there is provided a system comprising a processor, wherein the processor is configured to obtain, by using a generative artificial intelligence model, self-evaluation information of an employee and work plan information of the employee. The processor analyzes the obtained information and organizes project information, work time information, and characteristic information of the employee, thereby converting unstructured or semi-structured data into structured data that can be consistently evaluated.

The processor is further configured to identify an emotional state of the employee by using an emotion analysis engine. By applying emotion analysis to the self-evaluation information or related textual data, the processor can estimate whether the employee is, for example, overly optimistic, overly pessimistic, stressed, or otherwise emotionally biased at the time of self-evaluation.

Based on the identified emotional state, the processor adjusts an evaluation result for the employee. For example, the processor can correct or weight certain elements of the self-evaluation, moderate extreme evaluations, or provide context-sensitive interpretation of the employee's statements. In this way, the system can reduce the influence of emotional bias on the final evaluation result.

Through these functions, the processor automates evaluation of work efficiency of the employee so as to reduce time required for the evaluation, and comprehensively determines evaluation of work efficiency of the employee so as to improve efficiency of the evaluation, thereby enabling more accurate, fair, and efficient employee performance evaluations.

The term “system” refers to an integrated combination of hardware and software components, including at least one processor and associated memory, configured to execute programmed instructions to perform the functions described in the present specification and claims.

The term “processor” refers to one or more hardware processing units, such as a central processing unit (CPU), graphics processing unit (GPU), application-specific integrated circuit (ASIC), field-programmable gate array (FPGA), or any combination thereof, capable of executing instructions to perform arithmetic, logical, control, and input/output operations.

The term “generative artificial intelligence model” refers to a machine learning model configured to generate or transform data, including text, based on learned patterns from training data, and includes, for example, large language models, transformer-based models, and other neural network models capable of producing output content in response to input prompts.

The term “self-evaluation information” refers to information provided directly by an employee regarding the employee's own performance, achievements, contributions, strengths, weaknesses, and related subjective assessments for a given evaluation period.

The term “work plan information” refers to information that represents planned or scheduled work activities of an employee, including, for example, calendar entries, project schedules, task lists, meeting schedules, and other time-based or project-based planning data.

The term “project information” refers to information related to one or more projects in which an employee participates, including, for example, project identifiers, project names, roles of the employee, objectives, tasks, milestones, and outcomes.

The term “work time information” refers to information indicating an amount of time associated with work performed or planned by an employee, including, for example, working hours, time spent on particular projects or tasks, and distributions of work over an evaluation period.

The term “characteristic information of the employee” refers to information representing attributes, tendencies, or features of an employee's work behavior or performance, including, for example, skills, strengths, contributions, collaboration style, leadership tendencies, and other qualitative or quantitative characteristics derived from self-evaluation information and work plan information.

The term “emotion analysis engine” refers to a software and/or hardware module that analyzes input data, including textual data such as self-evaluation comments, in order to estimate or classify an emotional state, such as positivity, negativity, stress, satisfaction, or other emotional attributes of an employee.

The term “emotional state” refers to a condition or tendency of an employee's emotions or feelings at a given time or during a given period, including, for example, levels of positivity or negativity, stress, frustration, satisfaction, enthusiasm, or similar affective states as inferred from analyzed data.

The term “evaluation result” refers to an outcome of a performance evaluation process for an employee, including, for example, scores, ratings, qualitative assessments, summaries, and any combined metrics that represent an assessment of the employee's work efficiency or overall performance.

The term “work efficiency” refers to a measure of how effectively and productively an employee performs assigned tasks or contributes to projects, considering factors such as output, quality, timeliness, resource utilization, and achievement of goals or key performance indicators.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

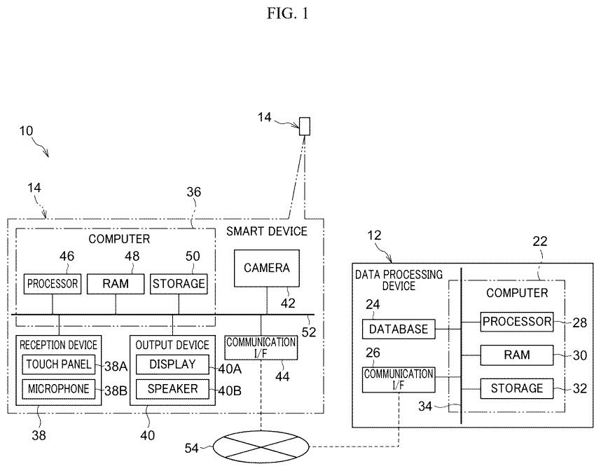

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

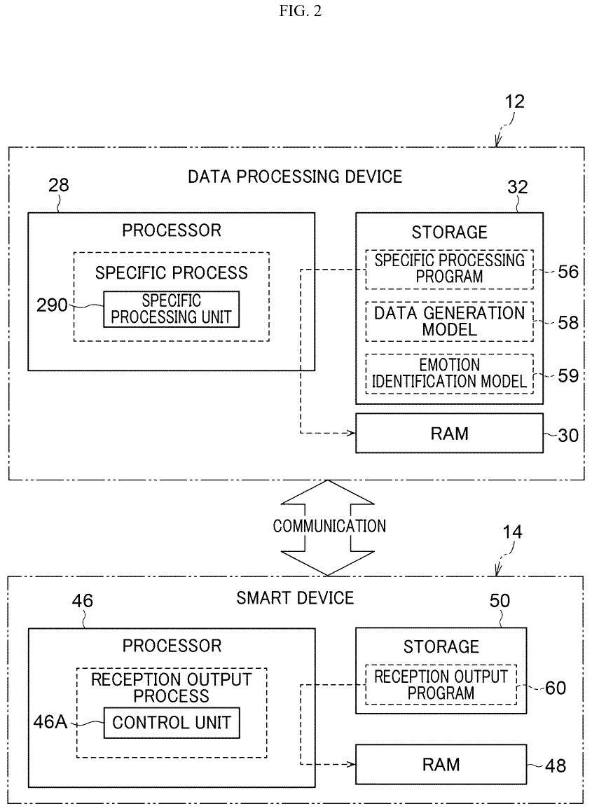

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional employee performance evaluation systems typically rely on static questionnaires, manual review of free-text self-evaluations, and separate access to time management records. In many implementations, free-text self-evaluation information submitted by employees is either reduced to coarse rating scales or manually interpreted by human evaluators. As a result, rich contextual information contained in natural-language descriptions, such as concrete examples of leadership, collaboration, or problem-solving, is not systematically captured or structurally analyzed. Furthermore, time management information, such as project participation records and working hours, is often stored in separate business applications and is not automatically correlated with the content of self-evaluations.

From a computer-technical perspective, existing systems generally treat natural-language self-evaluation text as opaque, unstructured data. Application servers may merely store and retrieve such text without performing fine-grained feature extraction or automated integration with other structured datasets. Consequently, the processor is not effectively utilized to transform heterogeneous inputs into higher-level, machine-usable evaluation features, and the overall data processing pipeline remains fragmented. This leads to inefficient use of computing resources, redundant manual operations, and increased latency between input of self-evaluation information and generation of evaluation results.

Moreover, known systems that apply machine learning to performance evaluation often require pre-labeled training datasets and fixed feature definitions, which makes it difficult to flexibly adapt to diverse expression patterns in self-evaluation text. In addition, even when analytic models are used, many systems do not provide a consistent mechanism for generating natural-language feedback to employees that is directly grounded in both self-evaluation content and time management information. This results in a lack of transparency and traceability in how evaluation scores are produced and presented.

Accordingly, there is a need for an improved computer-implemented evaluation system in which a processor can: (i) automatically receive and store self-evaluation information, (ii) generate context-specific prompt sentences to drive a generative AI model, (iii) obtain structured evaluation feature information from natural-language self-evaluations, (iv) automatically acquire and normalize time management information from external information sources, (v) integrate these heterogeneous data types using a defined evaluation algorithm, and (vi) generate natural-language feedback texts based on structured evaluation results. By tightly coupling generative AI-based text analysis and feedback generation with structured time management data processing, the processor can perform more efficient, automated, and technically robust evaluation operations, thereby improving the overall performance, scalability, and reliability of the evaluation system.

The specific processing by the specific processing unit 290 of the data processing device 12 in Example 1 is realized by the following means.

The present invention provides a server comprising a processor and a storage device, wherein the processor is configured to receive self-evaluation information of an evaluation target from a terminal and store the self-evaluation information in the storage device; generate a prompt sentence including natural language text comprising the self-evaluation information as input information, request an analysis process by a generative AI model using the prompt sentence, extract evaluation feature information from the self-evaluation information based on an analysis result acquired from the generative AI model, and store the evaluation feature information as intermediate data in the storage device; communicate with an external time management system serving as an external information source to acquire time management information of the evaluation target and store the acquired time management information in the storage device; integrate the evaluation feature information and the time management information, apply an evaluation algorithm to an integration result, and generate evaluation result data regarding a work performance state of the evaluation target; generate a prompt sentence including structured data comprising the evaluation result data as input information, request generation of a natural language feedback text by the generative AI model using the prompt sentence, acquire the natural language feedback text from the generative AI model, and store the natural language feedback text in association with the evaluation result data in the storage device; and transmit the evaluation result data and the natural language feedback text to the terminal so that the terminal displays the evaluation result data and the natural language feedback text. This enables the processor to implement an integrated, computer-technical workflow that transforms unstructured self-evaluation text and external time management data into structured evaluation features, automated evaluation scores, and consistent natural-language feedback, thereby reducing processing time, decreasing reliance on manual interpretation, improving utilization of computational resources, and enhancing the technical performance and scalability of the evaluation system.

The term “processor” refers to a hardware computation unit, such as a central processing unit or a graphics processing unit, or a combination thereof, that executes instructions of a computer program to perform data processing operations.

The term “terminal” refers to an information processing device operated by a user, such as a personal computer, a smart phone, a tablet, or a similar communication device, that transmits and receives data to and from a server over a communication network.

The term “storage device” refers to a non-transitory computer-readable medium, such as a magnetic storage, a semiconductor memory, an optical storage, or a combination thereof, that stores programs, input data, intermediate data, and output data for processing by the processor.

The term “self-evaluation information” refers to natural-language data describing a work performance state, achievements, or activities of an evaluation target, the data being input by the evaluation target or a related person through the terminal.

The term “evaluation target” refers to an entity to be evaluated by the system, such as an employee, a worker, or a person engaged in a task or project.

The term “natural language text” refers to character data expressed in a human language, such as sentences and phrases, that can be interpreted by a human reader and processed by natural language processing techniques.

The term “prompt sentence” refers to an instruction text or a set of instruction texts provided to a generative AI model, the instruction text including input information and specifying a content, format, or objective of an output to be generated by the generative AI model.

The term “generative AI model” refers to an artificial intelligence model, such as a large language model or a similar machine learning model, that generates output data including natural-language text based on input data and a learned parameter set.

The term “analysis process” refers to a computation sequence performed by the generative AI model or the processor to derive structured information, feature information, or summary information from input data including natural-language text.

The term “analysis result” refers to data output by the generative AI model or the processor in response to the analysis process, the data including one or more items derived from input information, such as categories, feature values, or scores.

The term “evaluation feature information” refers to structured data representing features related to evaluation categories, such as leadership, collaboration, time management, or similar aspects, the structured data being extracted from self-evaluation information or other input information.

The term “intermediate data” refers to data generated at an intermediate stage of processing by the processor, the data being stored in the storage device and used for subsequent processing to generate evaluation result data or feedback data.

The term “external time management system” refers to an information processing system, separate from the server, that records and provides time-related information of the evaluation target, such as working hours, project participation, and task allocation.

The term “external information source” refers to a system, service, or database that is different from the server and is accessible via a communication network to provide data such as time management information or other work-related information.

The term “time management information” refers to structured data indicating a temporal aspect of work activities of the evaluation target, including working hours, overtime hours, project-wise hours, work schedules, or similar indicators.

The term “integration result” refers to data obtained by combining, correlating, or aggregating a plurality of datasets, such as evaluation feature information and time management information, according to predetermined rules or algorithms.

The term “evaluation algorithm” refers to a computation procedure, implemented as software or firmware executed by the processor, that converts evaluation feature information and time management information into evaluation result data, for example by applying weighting, scoring, statistical processing, or machine learning.

The term “evaluation result data” refers to structured data representing an outcome of evaluation of a work performance state of the evaluation target, including scores, ratings, category-wise evaluations, or similar evaluation indicators.

The term “structured data” refers to data organized in a predefined format, such as key-value pairs, tables, records, or hierarchical data structures, that is suitable for machine processing using database operations or programmatic access.

The term “natural language feedback text” refers to natural-language text generated to provide feedback to the evaluation target regarding the evaluation result data, the text including comments, explanations, or suggestions expressed in a human language.

The term “communication network” refers to a wired or wireless network, such as the Internet, a local area network, a cellular network, or a combination thereof, through which the terminal, the server, and the external time management system exchange data.

The server executes the present invention using a network-connected computer system that includes at least one processor, a main memory, a non-transitory storage device, and a communication interface. The server runs on an operating system such as a general-purpose server operating system and uses middleware such as a web server, an application framework, and a relational database management system. The server communicates with one or more terminals operated by users via a communication network such as the Internet, and communicates with an external time management system via an application programming interface.

The terminal operates as a user interface device. The terminal is, for example, a personal computer, a smart phone, or a tablet that executes a web browser or a native application. The terminal presents natural-language questions to a user and transmits user input as self-evaluation information to the server. The user operates the terminal by reading prompt sentences, entering text into an input field, confirming the input, and causing the terminal to transmit the input via secure communication.

The server stores programs in the storage device. The programs include a web application, an API service, a data processing module, a model-integration module for a generative AI model, an evaluation algorithm module, and a feedback generation module. The server loads these programs into the main memory and the processor executes the programs to perform data acquisition, feature extraction, integration of heterogeneous data, evaluation computation, and feedback generation.

The server uses a generative AI model implemented as a large-scale neural network. In one embodiment, the generative AI model is a transformer-based language model. The model comprises an input embedding layer, a plurality of encoder-decoder layers or decoder-only layers using self-attention mechanisms, feed-forward sublayers, and an output projection layer. The server accesses the generative AI model through an API exposed by a model-serving component. The model-serving component may run on a separate computing system that contains one or more graphics processing units configured with deep learning libraries such as a general-purpose tensor computation framework.

The server uses a specific data structure to store self-evaluation information. The data structure includes a record identifier, a user identifier, a text field for natural-language self-evaluation, a timestamp, and a status field indicating a processing state. The server stores evaluation feature information in another data structure that contains the record identifier, a category identifier, a feature value, an evidence phrase, and a confidence value. The server stores time management information in tables such as a time summary table including total working hours and overtime hours, and a project participation table including project identifiers, roles, and hours. The server stores evaluation result data in a structure including the user identifier, a time period, overall scores, category-wise scores, and references to key phrases.

The server utilizes a specific form of prompt sentence to instruct the generative AI model to perform natural-language analysis. The server generates an analysis prompt sentence that includes instructions, output format constraints, and a self-evaluation text. For example, the server generates a prompt sentence such as:

“You are an HR performance analysis assistant.

Read the following self-evaluation text written by an employee.

Extract up to five key performance themes and classify each theme into one of the following categories: leadership, communication, problem-solving, technical expertise, collaboration, time management.

For each theme, provide:
the category name,
a short evidence phrase copied from the text,
a confidence score between 0.0 and 1.0.

Return the output as structured information that can be parsed programmatically.

Self-evaluation text:

‘I led the migration project, coordinated with cross-functional teams, and ensured we met the deadline despite several technical issues.’”

The server also generates a feedback-generation prompt sentence that converts structured evaluation result data into human-readable feedback. The server, for example, generates a prompt sentence such as:

“You are an HR performance reviewer.

Based on the following evaluation data, write a performance feedback comment in English.

Requirements:
length: 2-3 sentences,
tone: professional, positive, and specific,
highlight leadership and contribution to project success.

Evaluation data:

overall score: 4.5,

leadership score: 4.7,

collaboration score: 4.3,

time management score: 4.2,

key phrases: ‘led the migration project’, ‘coordinated with cross-functional teams’, ‘met the deadline’.”

The server configures the generative AI model so that the model does not simply repeat arbitrary natural-language text, but instead outputs machine-usable structures that support deterministic downstream processing. The server constrains the model output by specifying required fields, categories, and numerical ranges in the prompt sentence, and by post-processing the output according to a predefined schema. This configuration allows the server to execute validation routines that detect malformed or inconsistent outputs and perform fallback or correction operations. As a result, the server improves robustness of the overall computer system.

The server uses a feature extraction algorithm that transforms natural-language expressions into numerical and categorical features. The server assigns each evaluation category (such as leadership or collaboration) an internal category identifier and a vector representation. The server calculates feature quantities such as frequency of category-specific evidence phrases, intensity scores derived from confidence values, and coverage ratios across multiple projects. The server stores these feature quantities as numeric fields in the evaluation feature information. Because the server uses a consistent mapping between language-based evidence and numeric features, the server can efficiently index and query large volumes of evaluation data using database operations.

The server applies an evaluation algorithm that combines the evaluation feature information with the time management information. The server, for example, defines a scoring function where each category score is a weighted sum of (i) a feature intensity value output by the generative AI model and (ii) a normalized time-based indicator derived from working hours or role information. The server may construct a vector of features including, for each category, a language-derived score, total hours in relevant projects, number of leadership roles, and consistency indicators comparing statements in the self-evaluation text with recorded project participation. The server applies a parametric model, such as a linear model or a gradient-boosted tree model, trained on historical labeled data to convert this feature vector into an overall performance score. By using these specific data structures and algorithms, the server achieves improved computational efficiency in aggregating heterogeneous inputs and reduces the complexity of human intervention in the evaluation process.

The server uses a generative AI model that has been trained in advance on a large text corpus. In one embodiment, the server fine-tunes the model or configures the model using instruction-tuning techniques so that the model responds reliably to the specific prompt sentences defined by the system. The server may apply supervised learning where pairs of input self-evaluation texts and desired structured outputs are used to update model parameters. The server may use an optimization algorithm such as stochastic gradient descent or an adaptive optimization method. The server calculates an error function based on the difference between the generated structured outputs and reference labels, and the server updates model weights accordingly. Through this training process, the generative AI model develops an internal representation of evaluation-relevant language patterns that differ from simple keyword matching or rule-based approaches.

The server implements an internal rule set that post-processes outputs of the generative AI model in a manner that is distinct from manual review. For example, the server enforces a rule that each extracted theme must be associated with exactly one category from a predetermined list and that confidence scores outside a preset numeric range are rejected and recalculated. The server also employs non-conventional processing, such as dynamic threshold adjustment based on historical distributions of scores, clustering of feature vectors to detect outliers, and automatic re-prompting of the generative AI model when certain validation checks fail. These non-traditional procedures enable the server to achieve lower error rates and more consistent behavior in large-scale deployments.

The server improves computer technology in several respects. Because the server transforms unstructured, high-dimensional text data into compact, structured feature representations, database queries and aggregation operations execute faster, reducing processing latency in batch and interactive workloads. The server reduces network communication load by transferring concise structured results between components instead of entire raw texts for downstream modules. The server also reduces memory usage by storing compressed feature vectors and pre-aggregated scores instead of redundantly storing multiple copies of raw evaluation text. The integration of time management information with language-derived features allows the server to compute evaluation metrics in a vectorized fashion, improving throughput and scalability on multi-core and multi-node infrastructures.

The server improves accuracy relative to traditional systems by using model-based feature extraction that captures semantic relationships beyond simple word occurrence. In particular, the transformer-based architecture allows the generative AI model to attend to relevant context spans across long self-evaluation texts, generating more precise category assignments and evidence phrases. As a result, the server can compute scores that align more closely with actual work performance as reflected in time management records. The server also reduces human judgment errors by standardizing the evaluation procedure and by applying the same algorithmic criteria to all evaluation targets.

The server realizes a technical effect that is not merely automation of human reasoning. Human evaluators typically cannot handle simultaneous processing of large-scale textual corpora and time-series work records with consistent criteria. In contrast, the server uses a multi-stage pipeline that includes neural network-based natural language processing, feature vector construction, numeric scoring, and algorithmic validation. This processing pipeline is specifically designed to exploit the computational capabilities of the processor and associated hardware accelerators, and produces outputs in formats optimized for storage, retrieval, and further machine processing.

The server can be implemented in several alternative embodiments. In one embodiment, the generative AI model is hosted by a third-party model service and accessed through an external API. In another embodiment, the generative AI model runs locally on a dedicated inference server attached to the same local area network as the main server, with the processor dispatching inference requests via an internal protocol. In another embodiment, the server uses a plurality of generative AI models, each specialized for a different language or for different job categories, and selects an appropriate model based on metadata associated with the self-evaluation information.

The terminal can also take multiple forms. In one embodiment, the terminal is a browser-based client that renders a web page for input and display. In another embodiment, the terminal is a mobile application that provides additional features such as push notifications for evaluation completion. The terminal may implement local input validation to prevent transmission of empty or malformed self-evaluation text, thereby reducing unnecessary network traffic and server load.

The user interacts with the system by entering self-evaluation information, reviewing generated feedback, and optionally confirming or commenting on the evaluation result. The user may perform additional actions, such as requesting recalculation over a different evaluation period or triggering an anonymized export of feature data. The server responds to these operations using the same underlying structured data and evaluation algorithm, demonstrating that the system's core functionality is realized through technical processing rather than through a particular business rule.

The server can further integrate additional data sources, such as project management systems or communication activity logs, by extending the feature extraction and evaluation algorithms. In such variants, the server defines new feature types, modifies the evaluation algorithm to accept additional dimensions, and adjusts training procedures for the generative AI model or other machine learning models. This modular design allows the server to be adapted to different organizational environments while maintaining the same fundamental technical architecture and advantages.

Through these embodiments, the server, the terminal, and the user cooperate in a technically specific manner: the server orchestrates data flows and model computations, the terminal presents prompts and outputs and transmits user-generated input, and the user provides domain content that is converted into machine-processable structures. Because the server employs explicit data schemas, defined prompt sentences, a transformer-based generative AI model configuration, and algorithmic integration with time management information, the system as a whole provides a concrete technical implementation that improves data processing speed, accuracy, and resource utilization in comparison with conventional evaluation systems.

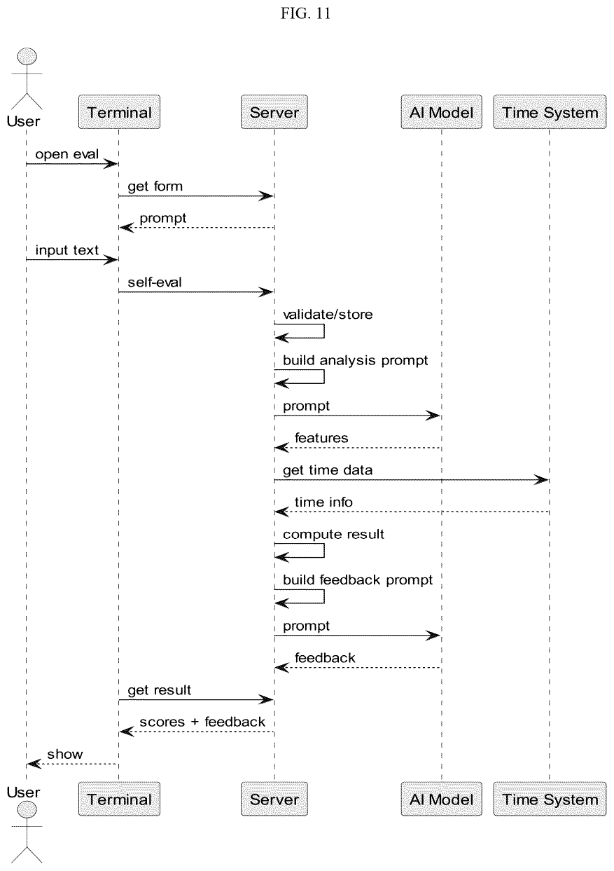

The following describes the processing flow using FIG. 11.

Step 1:

The terminal displays a prompt sentence and receives self-evaluation input from the user.

The terminal sends a request to the server to obtain a self-evaluation input screen. Based on a response from the server, the terminal renders a text input area and shows a prompt sentence such as “Please tell us what you contributed most to this year's projects.”

Input: A screen definition received from the server, including the prompt sentence and a user identifier.

Processing: The terminal presents the prompt sentence to the user and accepts natural-language input typed by the user.

Output: A data payload containing the user identifier and the self-evaluation text.

The terminal transmits this payload to the server over a secure communication channel.

Step 2:

The server validates and stores the received self-evaluation information.

Input: A data payload including the user identifier and the self-evaluation text sent from the terminal.

Processing: The server checks authentication of the user identifier, verifies that the self-evaluation text is not empty and is within a predetermined length, converts the text encoding to a unified format, and sanitizes characters to remove prohibited sequences. The server then inserts a new record into a self-evaluation table in a database, assigning a record identifier and setting a status value such as “PENDING_ANALYSIS.”

Output: A stored self-evaluation record consisting of the record identifier, the user identifier, the text, a timestamp, and the status.

The server confirms storage internally and may return a simple success response to the terminal.

Step 3:

The server prepares an analysis prompt sentence for the generative AI model.

Input: A self-evaluation record retrieved from the database where the status is “PENDING_ANALYSIS.”

Processing: The server reads the natural-language self-evaluation text and constructs an instruction string that contains: (i) a role description for the generative AI model, (ii) a specification of evaluation categories, (iii) requested output fields, and (iv) the self-evaluation text enclosed in delimiters. For example, the server generates a prompt sentence:

“You are an HR performance analysis assistant.

Read the following self-evaluation text written by an employee.

Extract up to five key performance themes and classify each theme into one of the following categories: leadership, communication, problem-solving, technical expertise, collaboration, time management.

For each theme, provide the category name, a short evidence phrase copied from the text, and a confidence score between 0.0 and 1.0.

Return the output as structured information that can be parsed programmatically.

Self-evaluation text:

‘I led the migration project, coordinated with cross-functional teams, and ensured we met the deadline despite several technical issues.’”

The server embeds the record identifier in metadata so that the result can be associated with the correct record.

Output: A prompt sentence string and associated metadata ready to be sent to the generative AI model.

Step 4:

The server sends the prompt sentence to the generative AI model and receives analysis output.

Input: The prompt sentence string and metadata generated in Step 3.

Processing: The server uses a model client library to create an inference request and transmits the prompt sentence to a generative AI model endpoint. The generative AI model, implemented as a transformer-based neural network, computes contextual embeddings for the input tokens, applies multiple attention layers and feed-forward layers, and generates an output text that encodes extracted themes, categories, evidence phrases, and confidence scores. The server receives this output text, which is formatted according to the requested schema. The server then parses the text and converts it into internal data objects or records representing evaluation feature information.

Output: Evaluation feature information that includes, for each extracted theme, a category identifier, an evidence phrase, and a confidence value associated with the record identifier.

The server stores this evaluation feature information in an analysis result table in the database and updates the status of the original self-evaluation record to “ANALYZED.”

Step 5:

The server acquires time management information from an external time management system.

Input: The user identifier and an evaluation period derived from configuration or from the self-evaluation record.

Processing: The server constructs a request message containing the user identifier and the evaluation period and sends it to an external time management system through an API. The external system retrieves working hours, project participation records, and roles for the user and returns data in a structured format. The server receives this data, validates the presence of required fields, and converts time values and project identifiers into a normalized internal format. The server then inserts or updates rows in a time summary table and a project participation table in the database.

Output: Stored time management information that includes total working hours, overtime hours, and per-project participation records linked to the user identifier and the period.

Step 6:

The server integrates the evaluation feature information with the time management information and computes evaluation result data.

Input: Evaluation feature information for the record identifier and time management information for the same user and period.

Processing: The server joins the feature records with the time management records on the user identifier and the evaluation period. The server constructs a feature vector for each evaluation target that contains: (i) language-derived feature scores per category, (ii) time-based indicators such as total project hours and number of projects led, and (iii) consistency indicators comparing claimed roles in the self-evaluation text with actual recorded roles. The server applies an evaluation algorithm that assigns weights to each component of the feature vector and calculates category-wise scores and an overall score. The server may also apply normalization across a population of users to keep scores within a defined range.

Output: Evaluation result data that includes an overall performance score, scores per evaluation category, and a list of key evidence phrases.

The server stores this evaluation result data in an evaluation results table in the database associated with the user identifier and the evaluation period.

Step 7:

The server generates a feedback-generation prompt sentence for the generative AI model.

Input: Evaluation result data retrieved from the evaluation results table for a specific user and period.

Processing: The server formats the scores and key phrases into a textual description and surrounds them with instructions that define the desired feedback style, length, and tone. For example, the server generates a prompt sentence:

“You are an HR performance reviewer.

Based on the following evaluation data, write a performance feedback comment in English.

Requirements:
length: 2-3 sentences,
tone: professional, positive, and specific,
highlight leadership and contribution to project success.

Evaluation data:

overall score: 4.5,

leadership score: 4.7,

collaboration score: 4.3,

time management score: 4.2,

key phrases: ‘led the migration project’, ‘coordinated with cross-functional teams’, ‘met the deadline’.”

The server ensures that all required values are included and that the prompt sentence does not exceed a predetermined character limit.

Output: A feedback-generation prompt sentence string prepared for submission to the generative AI model.

Step 8:

The server requests a natural-language feedback text from the generative AI model and stores the feedback.

Input: The feedback-generation prompt sentence produced in Step 7.

Processing: The server sends the prompt sentence to the generative AI model through the inference API. The generative AI model performs sequence generation by iteratively predicting output tokens conditioned on the prompt sentence and previously generated tokens, using its trained parameters. The server receives the generated feedback text, then runs validation checks such as maximum length, presence of disallowed terms, and conformity to basic grammatical requirements. If the text passes validation, the server associates the feedback text with the corresponding evaluation result record and writes it into a feedback field in the evaluation results table.

Output: A stored natural-language feedback text linked to the evaluation result data for the user and period.

Step 9:

The server delivers evaluation results and feedback to the terminal for display to the user.

Input: A retrieval request sent by the terminal that specifies the user identifier and the evaluation period.

Processing: The server queries the evaluation results table and retrieves the overall score, category-wise scores, and the stored feedback text for the specified user and period. The server formats these values into a response message suitable for rendering on the terminal, including labels, numeric values, and the natural-language feedback paragraph.

Output: A response message that contains the evaluation result data and the feedback text.

The terminal receives this message, renders the scores and comments on the display, and allows the user to read and optionally acknowledge or respond to the evaluation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for evaluating work efficiency of production facilities and workers mainly rely on rule-based metrics and static dashboards. In such systems, a processor typically computes simple key performance indicators from log data and then presents the indicators to a human supervisor. The interpretation, diagnosis, and proposal of improvement measures are left largely to human judgment. As a result, when data volume and complexity increase, the processor becomes a mere calculator and data-forwarder, and the overall system cannot scale in a way that fully leverages the available computational resources.

Further, conventional architectures generally treat machine-operation data and human-related data, such as self-evaluation information and emotional state, as separate data streams processed by different subsystems. The processor does not integrate these heterogeneous data types into a unified processing pipeline and therefore cannot generate coherent, context-aware analyses. This separation leads to fragmented storage structures, redundant query processing, and inefficient data flows, increasing latency and processing overhead on the computing platform.

Moreover, existing systems that call externally hosted machine learning services or artificial intelligence engines often send only raw or minimally processed data. The processor in such systems does not perform structured pre-aggregation, dynamic prompt construction, or validation of returned results, which leads to unnecessarily large payloads, high network usage, and unstable behavior of the external model. In particular, when a generative AI model is used, the lack of a systematic mechanism for embedding performance-evaluation data sets into prompt sentences causes the generative AI model to respond unpredictably, requiring additional manual filtering or reformatting by the user interface layer.

In addition, many known systems do not manage the interaction between an emotion-analysis engine and a generative AI model within a coordinated control flow executed by the processor. Emotional-state information, when available, is often displayed as a separate visualization and is not programmatically used to adjust evaluation results. This results in underutilization of computed emotional-state features and prevents the system from generating evaluation outcomes that are both data-driven and context-sensitive, thus limiting the technical effect of adding emotion analysis to the computing architecture.

There is therefore a need for an improved computer-implemented system in which a processor orchestrates acquisition, structured storage, preprocessing, prompt-based interaction with a generative AI model, integration of emotion-analysis outputs, and generation of display data in a unified and optimized pipeline. Such a system should technically improve how the processor manages heterogeneous data, reduce processing and communication overhead when interacting with an external generative AI model, and provide more efficient and accurate evaluation results through automated, machine-readable proposals and analyses that can be directly consumed by client devices without extensive manual post-processing. The technical problem is to provide an information processing architecture that enhances the functioning of the processor itself in terms of data orchestration, external AI-service interaction, and integrated analysis of facility-operation data and worker-related data.

The specific processing by the specific processing unit 290 of the data processing device 12 in Application Example 1 is realized by the following means.

The present invention provides a server comprising a processor configured to acquire heterogeneous work-related information, including self-evaluation-related information, work-plan-related information, and facility-operation-related information, from one or more data sources; structure and store operation-history information and work-time information acquired from detection devices of production facilities into a storage area; execute, by using data-analysis software, preprocessing on the stored operation-history information and work-time information, the preprocessing including missing-value correction, duplicate removal, time normalization, and aggregation processing, to generate a performance-evaluation data set on a per-facility basis; convert the performance-evaluation data set into a predetermined data format, embed the converted performance-evaluation data set into a prompt sentence, and transmit, as analysis request information, the prompt sentence to an information-processing infrastructure that operates a generative AI model; receive from the generative AI model a performance-evaluation result and efficiency-improvement-proposal information, and associate and store the performance-evaluation result and the efficiency-improvement-proposal information with task-unit information, work-time-related information, and worker-characteristic-related information; analyze, by using an analysis engine having an emotion-analysis function, the self-evaluation-related information to grasp an emotional state of a worker, and adjust the performance-evaluation result and an evaluation result with respect to the worker based on the emotional state; generate display data including the performance-evaluation result, the efficiency-improvement-proposal information, and the adjusted evaluation result, and transmit the display data to a terminal device for comparative display of work efficiency of the production facilities and work efficiency of the workers; and, in response to a user operation, retransmit to the generative AI model a prompt sentence input from the terminal device together with at least a part of the display data to obtain additional proposal information or additional analysis results. This enables an improved computer-centric workflow in which the processor itself is enhanced to orchestrate end-to-end data acquisition, preprocessing, prompt-based interaction with a generative AI model, and integration of emotion-analysis outputs, thereby reducing computation and communication overhead, stabilizing external AI-service behavior through structured prompt sentences, and producing more accurate and machine-usable evaluation results that can be efficiently rendered on client devices without extensive manual intervention.

The term “work-related information” refers to information that describes planning, execution, and evaluation of work performed within an organization, including but not limited to self-evaluation-related information, work-plan-related information, and facility-operation-related information.

The term “self-evaluation-related information” refers to information indicating a worker's own assessment of their performance, condition, or feelings regarding assigned tasks, typically including free-text comments, ratings, or selections entered by the worker.

The term “work-plan-related information” refers to information describing scheduled or intended work activities, including task assignments, target quantities, planned working time, and task sequences for workers and facilities.

The term “facility-operation-related information” refers to information representing the operational state of production facilities or equipment, including operation-history information, work-time information, and status information detected by sensors or control systems.

The term “task-unit information” refers to information that represents work segmented into discrete units such as tasks, jobs, or operations, each unit being associated with identifiers, assigned resources, and performance metrics.

The term “work-time-related information” refers to information indicating durations or timestamps associated with work, including planned working time, actual working time, idle time, and downtime for workers or facilities.

The term “worker-characteristic-related information” refers to information describing attributes of a worker relevant to task execution, such as skill level, role, experience, assigned department, or past performance metrics.

The term “operation-history information” refers to time-series or event-based records that indicate how a production facility or equipment has operated over time, including start and stop events, mode changes, production counts, and error occurrences.

The term “detection device” refers to a hardware device such as a sensor, meter, or controller that measures or detects physical or logical states of a production facility and outputs operation-history information or work-time information.

The term “work-time information” refers to information indicating the time taken by a facility or worker to perform specific work, including cycle time, processing time, setup time, and accumulated running time.

The term “storage area” refers to any physical or logical data storage resource, such as a memory device, database, or file system, used to store structured or unstructured data processed by the server.

The term “data-analysis software” refers to a software component or library that performs data transformation, cleansing, aggregation, or statistical computation on stored data, including operations such as missing-value correction, duplicate removal, normalization, and metric calculation.

The term “preprocessing” refers to a sequence of data-processing operations applied to raw or semi-structured data to transform the data into a standardized, cleaned, and aggregated format suitable for subsequent analysis, including missing-value correction, duplicate removal, time normalization, and aggregation.

The term “time normalization” refers to processing by which time-related values such as timestamps or durations are converted into a consistent representation, for example by aligning time zones, rounding to fixed intervals, or standardizing time formats.

The term “aggregation processing” refers to computing summary values from multiple records, such as sums, averages, counts, or ratios, for a specified grouping such as per facility, per worker, or per time interval.

The term “performance-evaluation data set” refers to a structured collection of data that has been preprocessed and aggregated to represent performance metrics for each facility or other evaluation unit, and that is suitable for input to a generative AI model or other analysis engine.

The term “predetermined data format” refers to a structured representation of data, such as a text format, a markup format, or a serialized data structure format, defined in advance so that both the server and a generative AI model can interpret the data.

The term “prompt sentence” refers to a sequence of one or more natural-language expressions, optionally including embedded structured data, which is transmitted to a generative AI model to specify an analysis task or generation task.

The term “analysis request information” refers to information transmitted from the server to an external information-processing infrastructure to request analysis or generation by a generative AI model, the information including at least a prompt sentence and associated data.

The term “information-processing infrastructure” refers to one or more computing resources, such as servers or cloud computing platforms, that execute a generative AI model and provide an interface through which external systems can submit analysis request information and receive results.

The term “generative AI model” refers to an artificial-intelligence model that, upon receiving a prompt sentence and optional structured data, generates new information such as evaluations, summaries, or proposals based on patterns learned from training data.

The term “performance-evaluation result” refers to data generated by the generative AI model or the processor that expresses an assessment of performance of facilities or workers, including scores, rankings, diagnoses, or natural-language explanations.

The term “efficiency-improvement-proposal information” refers to information generated by the generative AI model that proposes concrete actions or strategies for improving efficiency of facilities or workers, including recommendations such as parameter adjustments, schedule changes, or task reallocations.

The term “emotion-analysis function” refers to functionality of an analysis engine that processes text, numerical indicators, or other input signals to infer an emotional state, such as stress, satisfaction, or motivation, of a worker.

The term “analysis engine having an emotion-analysis function” refers to a software component that receives self-evaluation-related information or other worker-related data and outputs emotion-related indicators, labels, or scores representing an inferred emotional state.

The term “emotional state” refers to an inferred psychological or affective condition of a worker, such as being stressed, motivated, fatigued, or satisfied, as determined by the analysis engine having an emotion-analysis function.

The term “evaluation result with respect to the worker” refers to an assessment of a worker's performance or condition, which may include efficiency metrics, qualitative ratings, or combined scores that are optionally adjusted based on emotional-state information.

The term “display data” refers to data formatted for presentation on a user interface, including text, numerical values, and graphical-structure information, which collectively specify content to be rendered on a terminal device.

The term “terminal device” refers to an information processing device having a display device and an input interface, such as a workstation, personal computer, or mobile computing device, that communicates with the server to display information and receive user inputs.

The term “comparative display” refers to a visual presentation in which two or more sets of information, such as work efficiency of production facilities and work efficiency of workers, are shown in a manner that allows direct comparison, for example side-by-side or on a common scale.

The term “additional proposal information” refers to further efficiency-improvement suggestions generated by the generative AI model in response to a prompt sentence that is based on previously generated display data or user inputs.

The term “additional analysis results” refers to further analytical outputs generated by the generative AI model, such as deeper diagnostic explanations or scenario analyses, that supplement initial performance-evaluation results.

The term “user operation” refers to an action performed by a user at a terminal device, such as selecting a control, entering text, or adjusting a filter, which causes the terminal device to transmit a request or prompt sentence to the server.

The term “operation indicators” refers to quantitative measures that describe operational aspects of a production facility, such as produced quantity, cycle time, or number of operation cycles within a given period.

The term “utilization indicators” refers to quantitative measures that represent how intensively a production facility is used within a time period, such as a ratio of operating time to total available time.

The term “downtime-ratio indicators” refers to quantitative measures that indicate a ratio of downtime, including stoppages or idle periods, to a total time window for a facility.

The term “work-efficiency indicators” refers to quantitative measures of how effectively work is performed by workers or facilities, such as output per unit time, tasks completed per shift, or ratio of productive time to total time.

The term “heterogeneous work-related information” refers to work-related information of different types, structures, or sources, including machine-generated logs, human-entered evaluations, and schedule data, which are processed together by the server.

The term “client device” refers to a terminal device or similar computing device that communicates with the server to receive display data and present user interfaces for viewing evaluation results and proposals.

In one embodiment, a server includes a processor, a main memory, a non-volatile storage device, and a network interface. The server is connected, via an industrial network such as an Ethernet-based fieldbus or an industrial control network, to a plurality of detection devices mounted on production facilities, and is further connected, via an IP-based network, to one or more terminal devices operated by a user. The terminal is, for example, a personal computer, a workstation, or a tablet computer including a display device, an input device, a browser or dedicated client software, and a communication interface.

The server uses data-analysis software executed in the processor, such as a numerical computation library and a tabular-data processing library, to implement data acquisition, preprocessing, aggregation, and feature extraction on heterogeneous work-related information. The server also uses a communication library to exchange messages with the detection devices and with an external information-processing infrastructure that executes a generative AI model. The generative AI model is, in one embodiment, a multi-layer neural network of the transformer type, trained on a large corpus of text and structured data to perform conditional generation based on a prompt sentence and embedded auxiliary data.

The server stores, in the non-volatile storage device, a relational database that includes at least a facility-operation table, a worker-information table, a work-plan table, an emotion-analysis table, and an AI-evaluation table. The facility-operation table stores operation-history information and work-time information received from detection devices attached to production facilities. Each record in the facility-operation table includes fields such as facility identifier, timestamp, operation mode code, production count, and downtime duration. The worker-information table stores worker-characteristic-related information, including worker identifiers, skill levels, roles, and historical performance indicators. The work-plan table stores work-plan-related information, including planned tasks, target quantities, and planned working time. The emotion-analysis table stores emotional-state information inferred from self-evaluation-related information. The AI-evaluation table stores performance-evaluation results and efficiency-improvement-proposal information generated via interaction with the generative AI model.

The server uses the network interface to receive sensor messages from detection devices installed in production facilities. Each detection device can be implemented as a programmable logic controller or an industrial sensor node that outputs timestamped operation logs and work-time measurements using a structured packet format. The server parses these messages in the processor, maps fields onto logical columns in the facility-operation table, and persists the parsed information. Because the server structures and indexes this data before any external AI processing, the database engine can perform efficient time-range and facility-based queries, reducing query latency and improving cache locality in the storage system.

The server uses data-analysis software, including a tabular-data processing library, to load operation-history information and work-time information into memory as a tabular data structure. The server applies algorithmic preprocessing to this data, including missing-value correction by interpolation or filling with default values, duplicate record removal based on composite keys, conversion of timestamps to a unified time base, and aggregation by facility and time window. By executing these steps within the server prior to communication with the generative AI model, the server reduces the size and redundancy of data transmitted to the external infrastructure, thereby reducing network bandwidth usage and improving overall end-to-end processing time.

The server computes performance features for each facility. In one embodiment, the server derives operation indicators such as total produced units per time window, utilization indicators defined as operating time divided by total available time, downtime-ratio indicators defined as downtime divided by total time, and other derived metrics such as mean cycle time and standard deviation of cycle time. The server represents these features in a performance-evaluation data set in which each row corresponds to a facility and each column corresponds to a specific metric. By standardizing these metrics and aligning them with a fixed schema, the server enables deterministic construction of input features that are reproducible across analysis runs, which improves the stability of outputs generated by the generative AI model.

The server also acquires worker-related information. The server receives self-evaluation-related information and work-plan-related information from terminals. The terminal displays entry forms, such as text-entry fields and selection controls, through which a user who is a worker or supervisor enters subjective assessments, perceived workload, and planned tasks. The terminal transmits the entered data to the server via an application-layer protocol. The server stores the received self-evaluation-related information and work-plan-related information in corresponding tables in the database, linking them by foreign keys to worker identifiers and time intervals.

The server uses an analysis engine having an emotion-analysis function to process the self-evaluation-related information. In one embodiment, the emotion-analysis engine is implemented as a neural network model trained for sentiment and emotion classification on textual input. The model architecture, for example, includes an embedding layer that converts tokens into vectors, multiple attention-based layers that compute contextualized representations, and a final classification layer that outputs probability scores over emotion categories such as “stressed,” “neutral,” and “motivated.” The server feeds worker-entered text into this model, obtains probability scores, and stores these scores and the most probable label in the emotion-analysis table. Because the emotion-analysis engine operates in an automated and consistent manner, the server can apply the same classification logic across large volumes of subjective input, reducing bias and variability compared to manual tagging.

The server then constructs a performance-evaluation data set that integrates both facility-operation-related metrics and worker-related metrics. The server aligns records based on time windows and tasks, and joins the facility metrics with worker-assignment information to form composite records. Each composite record may include fields such as facility identifier, worker identifier, time window, operation indicators, utilization indicators, downtime-ratio indicators, worker-efficiency indicators, and emotion scores. This integrated data structure allows the generative AI model to consider machine state and worker state together when generating evaluation and proposal outputs.

The server constructs a prompt sentence to be transmitted to the external information-processing infrastructure that hosts the generative AI model. The server uses a template in which instructions, context, and structured data are combined in a deterministic order. In one example, the server constructs a natural-language prompt sentence such as:

“Based on the following operation data and worker information, evaluate the performance of each production facility and each worker, explain the main bottlenecks, and propose concrete measures to improve efficiency. Consider both machine utilization and worker emotional state. Data: [tabular metrics for each facility and worker]. Output a structured explanation and a list of recommended actions for each facility and each worker.”

In another example, when the server focuses analysis on a production robot, the server constructs a prompt sentence such as:

“Using the robot operation data below, perform a performance evaluation and generate proposals for efficiency improvement. Data: [time-series metrics of produced units, operation time, and downtime].”

The server embeds the performance-evaluation data set into the content of the prompt sentence. In one embodiment, the server converts the tabular data into a textual representation with headers and delimited values. The server places this representation in a clearly marked section of the prompt sentence, to guide the generative AI model to parse the data consistently. By controlling the placement and formatting of the data in the prompt, the server reduces ambiguity and improves the reproducibility of generated results.

The server uses the network interface to send the prompt sentence and associated context to the external information-processing infrastructure, such as a cloud-based AI service. The generative AI model, which is a transformer-based neural network, processes the tokenized prompt in multiple self-attention layers. Each layer applies learned weight matrices to compute attention scores and contextual embeddings, and the network successively refines a representation of the prompt and embedded data. The generative AI model then decodes, step by step, a sequence of output tokens representing a natural-language explanation and structured recommendations. During training, the model was optimized to minimize a cross-entropy loss between predicted tokens and reference tokens, with weight updates computed by backpropagation and applied via a gradient-based optimizer such as Adam. As a result, the trained model has internal parameters that encode statistical relationships between performance-related textual patterns and improvement suggestions.

The server receives the output sequence from the generative AI model via the network interface. The server parses the generated text and extracts logical segments, such as a performance-evaluation result portion and an efficiency-improvement-proposal portion. In one embodiment, the server uses predefined markers or headings requested in the prompt sentence to segment the response. The server converts the parsed segments into structured fields and stores them in the AI-evaluation table. The server may also perform sanity checks, such as verifying that essential elements (for example, at least one recommendation per facility) are present and that numerical values, if any, fall within expected ranges. If anomalies are detected, the server logs the response for later inspection and may trigger regeneration with adjusted prompt parameters.

The server associates the performance-evaluation results and efficiency-improvement-proposal information with the corresponding task-unit information, work-time-related information, and worker-characteristic-related information by joining tables on common identifiers and time intervals. The server then generates display data that includes, for example, facility performance scores, worker performance scores, lists of recommended actions, and indications of worker emotional states. The display data may be represented as structured objects comprising numeric values, text labels, and graphical parameters such as chart types and color codes. Because this display data is structured, the terminal can render the information without performing heavy computation, thereby offloading processing from client devices and centralizing complex analysis on the server.

The terminal receives the display data from the server and renders user interfaces that visually compare work efficiency of facilities and workers. The terminal draws graphs such as line charts for throughput over time, bar charts for facility comparison, and color-coded indicators for emotional state. The terminal displays recommendations as textual lists linked to specific facilities and workers. The user, who may be a manager or operator, interacts with these interfaces to inspect performance and explore recommended actions. The terminal transmits user commands, such as requests for more detailed analysis of a particular facility, back to the server.

The server, upon receiving a request from a terminal, can construct additional prompt sentences that focus on subsets of the data. For example, when the user selects a specific facility, the server can construct a prompt sentence such as:

“Analyze the following detailed operation log for Facility X over the past 24 hours. Identify the main causes of downtime, quantify their impact, and propose specific operational changes to reduce downtime in the next 24 hours.”

The server embeds high-resolution time-series data for the selected facility into this prompt sentence, transmits it to the generative AI model, and receives an additional analysis result. The server integrates this additional result into new display data, which the terminal renders in a detailed view. This interactive loop enables the server to use the generative AI model as a specialized inference engine that can be dynamically steered by user inputs and real-time data.

The server uses emotion-analysis outputs to adjust evaluation results. For instance, if the emotion-analysis engine indicates a high probability that a worker is under stress, the server may adjust performance thresholds or interpret deviations differently. By encoding adjustment rules within the processor, rather than leaving them to ad hoc human interpretation, the system systematically accounts for emotional state in its evaluations. This technical mechanism allows more nuanced and accurate interpretation of performance anomalies and reduces false positives in alerting or reporting systems.

The server improves computer technology in several ways. First, by pre-aggregating and feature-engineering facility-operation and worker-related data before contacting the generative AI model, the server reduces the volume of data transmitted, minimises network load, and shortens analysis latency. Second, by using deterministic prompt construction with embedded performance-evaluation data sets, the server stabilizes outputs from the generative AI model and reduces variance across calls, improving reliability of AI-assisted evaluation. Third, by integrating emotion-analysis outputs into a unified pipeline and programmatically adjusting evaluation results based on quantified emotional states, the server creates a new internal processing layer that did not exist in conventional systems, improving both accuracy and robustness of evaluation results.

The system's processing is not limited to abstract data manipulation. The server uses results generated by the generative AI model to derive operations that can be applied to production facilities. For example, the server can generate configuration parameters for programmable logic controllers or scheduling parameters for a production management system. The server may, after human confirmation via the terminal, transmit control messages that adjust shift allocation, machine speed, or maintenance schedules. By establishing a loop in which sensor data flows through feature extraction, generative AI evaluation, and back into system-level control parameters, the server influences actual physical processes in the production environment. This provides a concrete technical application in which the improved computational pipeline yields measurable effects on throughput, downtime, and resource utilization.

Multiple variations are possible within the scope of the foregoing description. In one variant, the server uses a different type of generative AI model, such as a sequence-to-sequence neural network with recurrent layers, provided that the model can consume a prompt sentence and output natural-language explanations and recommendations. In another variant, the server represents the performance-evaluation data set as a hierarchical or graph-structured data model, and encodes this model into the prompt sentence using a specially designed serialization scheme. In yet another variant, the server hosts the generative AI model locally on a dedicated accelerator device rather than relying on an external infrastructure, thereby reducing latency and enabling tighter integration with local data resources.

The server can also apply non-standard rule-based post-processing to the outputs of the generative AI model. For example, the server can enforce domain-specific constraints, such as maximum allowable machine speed or safety-related rules, when transforming textual recommendations into actionable control parameters. The server may implement a rule engine that parses the proposed actions and filters, modifies, or augments them according to predefined technical constraints. This combination of statistical generative modeling and deterministic rule-based enforcement allows the system to benefit from flexible, learned reasoning while maintaining adherence to technical and safety requirements.

By orchestrating these components—structured data storage, algorithmic preprocessing, deterministic prompt construction, transformer-based generative modeling, emotion analysis, and rule-based post-processing—the server implements a concrete and improved computer-implemented architecture. This architecture enhances processing efficiency, improves accuracy and stability of AI-assisted evaluations, reduces communication overhead, and links computational results to control and configuration operations in the physical production environment. The terminal and user cooperate with the server in this architecture, but the core improvements reside in the way the server processes, structures, and uses data and AI models, rather than in mere automation of a human mental process.

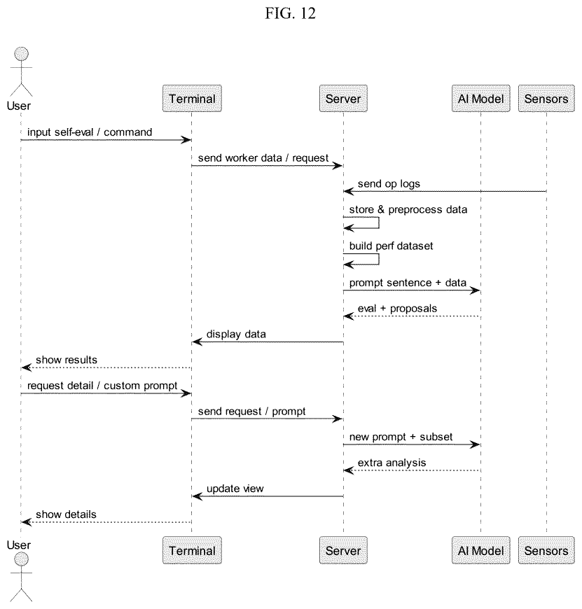

The following describes the processing flow using FIG. 12.

Step 1:

The server acquires raw facility-operation-related information from detection devices attached to production facilities.

The input to this step is a stream of sensor messages that include timestamps, facility identifiers, operation mode codes, production counts, and raw time measurements.

The server parses each message using a communication library, validates required fields, converts binary or protocol-specific formats into internal data records, and writes the structured records into a facility-operation table in a database.

The output of this step is a set of stored operation-history information and work-time information, indexed by facility identifier and timestamp.

Step 2:

The server acquires worker-related information from the terminal.

The input to this step is form data entered by the user at the terminal, including self-evaluation-related information, work-plan-related information, and worker identifiers.

The terminal sends the entered data to the server over a network connection, and the server receives and validates the data, checking for completeness and correct formats.

The server stores the validated self-evaluation-related information and work-plan-related information into corresponding tables in the database, linking them to worker records. The output of this step is a set of stored worker-related records associated with specific workers and time intervals.

Step 3:

The server performs preprocessing on the stored facility-operation-related information.

The input to this step is a batch of records read from the facility-operation table, selected by a time range and by facility identifiers.

The server loads the records into a tabular data structure in memory, removes duplicate rows based on composite keys of facility identifier and timestamp, fills missing values using predefined rules, normalizes timestamp formats and time zones, and aggregates records into fixed time windows per facility.

The output of this step is a cleaned and aggregated operation data set that provides summarized metrics per facility and time window.

Step 4:

The server computes performance features for each facility.

The input to this step is the cleaned and aggregated operation data set from Step 3.

The server calculates derived metrics such as total produced units, operating time, downtime, utilization rate, downtime ratio, average cycle time, and variability in cycle time.

The server appends these derived metrics as new columns to the tabular data structure and normalizes them if necessary, for example by scaling or standardizing values.

The output of this step is a performance-evaluation data set on a per-facility basis with a fixed feature schema.

Step 5:

The server computes worker-efficiency indicators and associates them with facility data.

The input to this step is the work-plan-related information and actual work-time-related information for each worker, together with assignment information that links workers to facilities and time windows.

The server calculates worker-efficiency indicators such as tasks completed per unit time, adherence to planned schedules, and ratio of productive time to total logged time.

The server joins the worker-efficiency indicators with the facility performance-evaluation data set by matching time windows and assignment relationships, thereby producing composite records that include both facility and worker metrics.

The output of this step is an integrated performance-evaluation data set that contains facility indicators and worker indicators for each analysis unit.

Step 6:

The server applies emotion analysis to the self-evaluation-related information.

The input to this step is a collection of self-evaluation texts and associated worker identifiers and timestamps.

The server forwards the text segments to an emotion-analysis engine implemented as a neural network classifier, receives probability scores for different emotional categories, and determines an emotional state label for each record.

The server stores the emotional-state scores and labels in the emotion-analysis table and links them to workers and time windows.

The output of this step is a set of emotion-analysis records that quantify emotional states for workers over time.

Step 7:

The server aligns emotional-state information with performance metrics.

The input to this step is the integrated performance-evaluation data set from Step 5 and the emotional-state records from Step 6.

The server matches records based on worker identifier and time window, merging emotion scores and labels into the composite performance records.

The server resolves overlaps or conflicts when multiple emotional records exist for a given time window, for example by selecting the record closest in time or by averaging scores.

The output of this step is an enriched evaluation data set that includes facility indicators, worker indicators, and emotional-state information.

Step 8:

The server constructs a prompt sentence for a generative AI model using the enriched evaluation data set.

The input to this step is the enriched evaluation data set and a prompt template stored in the server.

The server converts the tabular metrics into a textual representation, inserts this representation into designated positions in the template, and adds natural-language instructions and constraints for the generative AI model.

For example, the server may generate a prompt sentence such as:

“Based on the following operation data for each facility and worker, evaluate performance, explain the main bottlenecks, and propose concrete improvement measures. Consider both machine utilization and worker emotional state in your analysis. Data: [tabular metrics].”

The output of this step is a completed prompt sentence containing both instructions and embedded performance data.

Step 9:

The server transmits the prompt sentence to an external information-processing infrastructure that hosts the generative AI model.

The input to this step is the constructed prompt sentence from Step 8 and configuration parameters such as model identifier and generation settings.

The server packages the prompt sentence into a request message, attaches necessary metadata, and sends the message via a network protocol to the generative AI endpoint.

The server then waits for a response and manages network-level errors or timeouts through retries or fallback mechanisms.

The output of this step is an outbound analysis request and, after processing, an inbound response message from the generative AI model.

Step 10:

The server receives and parses the response from the generative AI model.

The input to this step is the response message containing a generated text produced by the generative AI model in reaction to the prompt sentence.

The server separates the generated text into logical segments, such as overall performance summaries, per-facility evaluations, per-worker evaluations, and lists of efficiency-improvement proposals, by using predefined cues and formatting patterns included in the response.

The server converts these segments into structured data records, performing any necessary type conversions for numerical values and cleaning of formatting artifacts.

The output of this step is a structured representation of performance-evaluation results and efficiency-improvement-proposal information.

Step 11:

The server validates and stores the AI-generated evaluation results.

The input to this step is the structured performance-evaluation results and efficiency-improvement-proposal information from Step 10.

The server checks that required fields are present, that recommendations are assigned to valid facility and worker identifiers, and that any quantitative values fall within reasonable bounds.

If validation succeeds, the server writes the evaluation results and proposals into the AI-evaluation table and links them with the corresponding records in the integrated evaluation data set; if validation fails, the server logs the problematic response for later review.

The output of this step is a persistent set of AI-generated evaluations and proposals stored in the database.

Step 12:

The server adjusts evaluation results using emotional-state information.

The input to this step is the AI-generated evaluation results and the corresponding emotional-state records associated with each worker.

The server applies predefined adjustment rules, such as modifying thresholds, weighting scores, or annotating evaluations, based on emotion scores that indicate stress, fatigue, or motivation.

Through these computations, the server generates adjusted evaluation results that quantitatively and qualitatively reflect both performance metrics and emotional states.

The output of this step is a set of adjusted evaluation results for facilities and workers.

Step 13:

The server generates display data for the terminal.

The input to this step is the adjusted evaluation results, the efficiency-improvement-proposal information, and underlying performance metrics.

The server assembles a display model containing numerical data for charts, textual summaries, labels for emotional states, and lists of recommended actions, formatted as a structured object suitable for transmission.

The server may also compute derived visualization parameters, such as color codes based on thresholds or sorting orders for ranking facilities and workers.

The output of this step is display data ready to be rendered on the terminal.

Step 14:

The terminal requests and receives the display data from the server.

The input to this step is a user action, such as opening a dashboard screen or refreshing a view, which causes the terminal to send a request message to the server.

The terminal receives the display data sent by the server in response and parses the data into internal structures compatible with a user interface library.

The terminal then interprets chart specifications, text fields, and layout elements contained in the display data.

The output of this step is a prepared user interface state that can be drawn on the display device.

Step 15:

The terminal renders comparative views of facility and worker efficiency.

The input to this step is the prepared user interface state from Step 14, including chart data, labels, and recommendations.

The terminal draws graphs such as time-series charts of throughput, bar charts comparing utilization across facilities, and icons or color markers representing worker emotional states and adjusted evaluations.

The terminal also renders lists or tables of efficiency-improvement proposals and links each proposal to the relevant facility or worker for easy navigation.

The output of this step is a set of visual screens displayed to the user, showing comparative efficiency information and recommendations.

Step 16:

The user interacts with the displayed information to request additional analysis.

The input to this step is the set of visual screens that show performance, emotional states, and proposals for each facility and worker.

The user selects interface controls, such as filters for date ranges and facility identifiers, or clicks on specific items to request more detailed explanations or focused analysis.

The user may also type a custom prompt sentence into an input field, such as: “Using today's operation data for all robots, propose a shift allocation that minimizes downtime while maintaining target output.”

The output of this step is a set of user commands and optional custom prompt sentences transmitted from the terminal to the server.

Step 17:

The server processes user commands and, if applicable, constructs additional prompt sentences.

The input to this step is the user commands and custom prompt sentences received from the terminal.

The server interprets selection commands as requests for different subsets of the stored data and executes database queries to retrieve the relevant facility and worker records.

If a custom prompt sentence is provided, the server embeds the selected data subset into the user-specified prompt, forming a new prompt sentence for the generative AI model.

The output of this step is either refreshed display data based on filtered queries or a new prompt sentence prepared for further AI-based analysis.

Step 18:

The server obtains additional analysis from the generative AI model based on user-driven prompts.

The input to this step is the new prompt sentence and the associated data subset constructed in Step 17.

The server sends this prompt sentence to the generative AI model, receives generated explanations or additional proposals, parses the response, and validates the new information similarly to Steps 9 and 10.

The server attaches the additional analysis to the relevant facilities and workers and generates updated display data accordingly.

The output of this step is an extended set of AI-generated analyses and recommendations tailored to the user's interactive requests.

Step 19:

The user reviews updated results and may authorize application of selected recommendations.

The input to this step is the updated display data showing additional analyses and detailed recommendations.

The user examines the proposed actions, such as adjusting production schedules or changing facility parameters, and may decide to approve certain recommendations by selecting confirmation controls on the terminal.

The user's approvals are transmitted as control instructions or confirmed actions to the server.

The output of this step is a set of user-approved actions recorded by the system.

Step 20:

The server logs user-approved actions and optionally prepares control outputs for external systems.

The input to this step is the set of user-approved actions from Step 19.

The server writes these actions into a decisions table linked to the underlying AI-generated proposals and performance records, enabling later evaluation of the effectiveness of recommendations.

Optionally, the server converts certain approved actions into control messages or configuration updates that can be consumed by external production-management or control systems, thereby enabling practical changes in facility operation based on the analytical pipeline.

The output of this step is a persistent log of decisions and, when enabled, outgoing control or configuration data directed at external systems.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented employee performance evaluation systems largely rely on static rule engines, manual data aggregation, or simple score calculations. Such systems typically treat input data, including self-evaluation information, work schedules, work logs, and goal definitions, as isolated data points. As a result, these systems lack an effective mechanism for (i) consistently transforming heterogeneous employee-related data into a unified representation suitable for machine reasoning, (ii) dynamically generating natural-language evaluation instructions tailored to the actual metrics for each employee, and (iii) leveraging a generative AI model to produce nuanced, context-aware performance evaluations while maintaining traceability to the underlying data.

In many existing solutions, engineers must hand-craft evaluation rules and narrative templates, which leads to rigid logic that is difficult to maintain and adapt to new roles, projects, or organizational policies. Additionally, when self-evaluation information and plan information (such as schedules or planned tasks) are available, conventional systems do not effectively compare these subjective inputs with objective indicators (such as work time, goal achievement ratios, or efficiency metrics) in a systematic and repeatable manner. This results in evaluations that are either oversimplified or heavily dependent on human interpretation, thereby limiting consistency, scalability, and auditability.

Furthermore, although generative AI models can produce rich natural-language content, naive integration of such models into performance evaluation workflows often treats them as black boxes: raw or loosely structured data is simply fed into the model, and the resulting text is stored without clear mapping to specific metrics, without a controlled prompt design, and without support for subsequent human refinement and versioning. This makes it difficult to ensure that the model's outputs are grounded in the actual data, to verify the reasoning steps, or to combine automatic evaluation with human review in a structured, machine-processable way.

Accordingly, there is a need for an improved computer-implemented technique that (i) programmatically aggregates and normalizes multi-source employee-related data, (ii) constructs internal evaluation summaries and converts them into explicit, structured prompt sentences for a generative AI model, (iii) systematically requests the model to evaluate consistency and discrepancy between subjective and objective indicators, and (iv) stores the AI-generated results in a way that is tightly associated with the underlying metrics and that can be augmented by human input. Such a technique should improve the functioning of the computer system itself by providing a defined processing pipeline—from data acquisition and feature generation, through prompt construction and AI inference, to result structuring and storage—thus enhancing reliability, scalability, explainability, and integration of generative AI within performance evaluation systems.

The specific processing by the specific processing unit 290 of the data processing device 12 in Example 2 is realized by the following means.

The present invention provides a server comprising a processor configured to acquire, from a user terminal and a storage device, evaluation request information and employee-related information including self-evaluation information, behavior schedule information, work performance information, goal information, and attribute information for an evaluation target; to preprocess the employee-related information by removing unnecessary information, normalizing numerical information, and extracting predetermined keywords from text information so as to generate evaluation feature information including participation task information, work time information, role information, goal achievement information, and capability characteristic information; to associate, based on the evaluation feature information, goal information and performance information for each evaluation target and for each work unit, to calculate goal achievement indices and work efficiency indices, and to generate internal evaluation summary information including results of the calculation; to convert the internal evaluation summary information into a natural-language prompt sentence including instruction information regarding evaluation viewpoints, evaluation scales, output formats, and comparative analysis between subjective information and objective indices; to input the prompt sentence to a generative AI model included in a generative information processing unit and to cause the generative AI model to generate work performance evaluation information for the evaluation target; to analyze the work performance evaluation information to extract structured elements including summary information, strength information, improvement-required information, and comprehensive evaluation indices, and to store extracted results as evaluation result information in the storage device in association with the corresponding evaluation feature information and internal evaluation summary information; and to transmit the evaluation result information to the user terminal and to receive and store additional information or correction information from a user so that human-authored annotations are managed in association with the evaluation result information generated by the generative AI model. This enables an improved computer-implemented evaluation pipeline in which heterogeneous employee-related data is systematically transformed into model-ready prompt sentences, generative AI outputs are constrained and grounded by explicit internal summaries and instructions, and the resulting evaluations are stored and refined in a structured, machine-processable form, thereby enhancing consistency, scalability, transparency, and integration of generative AI within employee performance evaluation systems.

The term “processor” refers to a hardware computation element, such as a central processing unit or other programmable processing circuitry, configured to execute machine-readable instructions to perform data acquisition, data transformation, prompt generation, model invocation, and result management as described herein.

The term “generative information processing unit” refers to a functional unit including hardware resources and software components that provide access to a generative AI model and that perform inference processing based on an input prompt sentence to generate natural-language or structured output.

The term “user terminal” refers to an information processing device, such as a personal computer, a mobile communication device, or a tablet device, operated by a human user to transmit evaluation request information and to receive and display evaluation result information from the server.

The term “evaluation request information” refers to information transmitted from the user terminal to the server and including at least an identification of an evaluation target and a period to be evaluated, and optionally including project identifiers, evaluation type indicators, and control parameters for an evaluation process.

The term “evaluation target” refers to an entity, such as an individual worker or a work role, for which work performance is to be evaluated by the system.

The term “self-evaluation information” refers to descriptive or quantitative information provided by the evaluation target regarding the evaluation target's own performance, contributions, or behavior during a specified period.

The term “behavior schedule information” refers to information indicating planned or recorded schedules of the evaluation target, including events, tasks, or appointments that represent intended or executed work activities during the evaluation period.

The term “work performance information” refers to information indicating actual work activities and results of the evaluation target, including, for example, work time records, completed task records, output artifacts, and performance metrics.

The term “goal information” refers to information defining performance objectives, target values, or key performance indicators that are set in advance for the evaluation target or for a work unit during an evaluation period.

The term “attribute information” refers to information representing characteristics of the evaluation target, such as role category, job level, skill category, or organizational affiliation, that are relevant to interpreting performance data.

The term “storage device” refers to a non-transitory computer-readable recording medium, such as a magnetic storage, a semiconductor memory, or a solid-state drive, configured to store data including employee-related information, evaluation feature information, internal evaluation summary information, and evaluation result information.

The term “preprocess” refers to a sequence of data processing operations performed on raw employee-related information, including removal of unnecessary information, normalization of numerical information, and extraction of structured elements from unstructured text information.

The term “unnecessary information” refers to data fields or records that are not required for calculating goal achievement indices, work efficiency indices, or generating evaluation results, such as obsolete records outside the evaluation period or internal diagnostic data.

The term “normalize numerical information” refers to transforming numerical values into a standardized representation, for example by converting units, scaling to a common range, or aggregating values by project or period, to facilitate consistent analysis and comparison.

The term “predetermined keywords” refers to terms or phrases defined in advance, such as words indicating skills, strengths, or performance attributes, which are extracted from text information to derive structured capability characteristic information.

The term “evaluation feature information” refers to structured information generated by preprocessing employee-related information, the structured information including at least participation task information, work time information, role information, goal achievement information, and capability characteristic information.

The term “participation task information” refers to information indicating tasks, activities, or work items in which the evaluation target has participated during the evaluation period.

The term “work time information” refers to information indicating time spent by the evaluation target on one or more tasks or work units, including, for example, total hours and distribution of hours among tasks or projects.

The term “role information” refers to information indicating the function or position of the evaluation target within a project or work unit, such as leader, contributor, or reviewer.

The term “goal achievement information” refers to information indicating a degree to which one or more predefined goals have been met, partially met, or not met, based on actual performance data.

The term “capability characteristic information” refers to information indicating inferred or declared capabilities, strengths, or skill attributes of the evaluation target derived from profile data, self-evaluation comments, and other text information.

The term “work unit” refers to a unit of work organization such as a project, task group, or activity category for which performance is evaluated.

The term “goal achievement indices” refers to one or more numerical indicators calculated based on goal information and performance information to quantify the achievement level of corresponding goals.

The term “work efficiency indices” refers to one or more numerical indicators calculated to represent efficiency of the evaluation target, such as output per unit time or tasks completed per defined period.

The term “internal evaluation summary information” refers to structured data generated by the processor that summarizes, for each evaluation target and work unit, associated goals, performance metrics, goal achievement indices, work efficiency indices, and related contextual elements, prior to generation of a prompt sentence.

The term “prompt sentence” refers to a natural-language instruction text generated by the processor based on internal evaluation summary information, and intended to be provided as input to a generative AI model to control the content, viewpoint, and structure of the model's output.

The term “instruction information” refers to information included within the prompt sentence specifying evaluation viewpoints, evaluation scales, output formats, and comparative analysis requirements, thereby constraining the behavior of the generative AI model.

The term “generative AI model” refers to a machine-learning model configured to generate natural-language or structured output in response to an input prompt, using learned statistical or neural network parameters.

The term “work performance evaluation information” refers to information generated by the generative AI model in response to the prompt sentence, the information including a natural-language assessment or structured assessment of the evaluation target's work performance.

The term “summary information” refers to a condensed description, generated or extracted by the processor, that provides an overview of the evaluation target's performance during the evaluation period.

The term “strength information” refers to information indicating positive aspects, advantages, or strong capabilities of the evaluation target as identified in the work performance evaluation information.

The term “improvement-required information” refers to information indicating aspects, behaviors, or capabilities of the evaluation target that require enhancement or corrective action, as identified in the work performance evaluation information.

The term “comprehensive evaluation indices” refers to one or more aggregated or composite numerical indicators representing an overall performance rating or overall evaluation score for the evaluation target.

The term “evaluation result information” refers to information stored in the storage device that includes structured outputs derived from the work performance evaluation information, such as summary information, strength information, improvement-required information, and comprehensive evaluation indices, and that is associated with corresponding evaluation feature information and internal evaluation summary information.

The term “additional information” refers to human-authored content, such as comments or explanations, provided by a user in relation to evaluation result information.

The term “correction information” refers to user-provided modifications, overrides, or adjustments to evaluation result information originally generated by the generative AI model.

The term “integrated human resource evaluation information” refers to combined evaluation information that integrates evaluation result information generated by the generative AI model with additional information and correction information provided by one or more human users.

In one embodiment, a server, a terminal, and a user cooperate to implement a computer-implemented employee performance evaluation system that uses a generative AI model. The server includes at least one processor, a main memory, a non-volatile storage device, and a network interface. The processor may be a multi-core central processing unit. The memory may be a semiconductor memory. The storage device may be a magnetic storage or a solid-state drive. The network interface may be an Ethernet or wireless interface. The terminal may be a personal computer, a tablet device, or a mobile communication device, equipped with a display, an input device such as a keyboard or a touch screen, a processor, and a network interface. The user operates the terminal to issue evaluation requests and to browse and annotate evaluation results.

The server executes software including an operating system such as a general-purpose server operating system, an application framework such as a web application framework, a database management system such as a relational database, and a set of application modules implemented, for example, in a high-level programming language. The server may further include a client library for accessing a generative AI model over a network or for accessing a locally hosted model through an inference server. The database stores employee-related tables, including tables for self-evaluation information, schedule information, work performance information, goal information, attribute information, internal evaluation summary information, and evaluation result information.

The server generates and executes a program that defines several cooperating modules, including at least a data acquisition module, a preprocessing and feature generation module, an internal summary generation module, a prompt generation module, a generative AI invocation module, a result parsing and structuring module, and a user interaction management module. Each module is implemented as executable instructions and operates on specific data structures stored in the memory and the storage device.

The server uses the data acquisition module to retrieve employee-related information from the storage device in response to evaluation request information received from the terminal. The server structures this employee-related information in an internal representation, for example, a set of nested records or objects that encode, for each evaluation target, associations between identifiers (such as employee identifiers, project identifiers, and period identifiers) and raw fields (such as free-text comments, time stamps, and numeric metrics). The server uses indexed access paths and pre-computed relations in the database so that these retrieval operations are executed with low latency.

The server uses the preprocessing and feature generation module to transform the retrieved raw records into evaluation feature information. The server, for example, uses a data processing library such as a tabular data manipulation library to normalize numerical fields. The server aggregates per-day work time records into per-project and per-period totals, converts units where necessary, and scales scores to a predetermined numerical range. The server uses a natural language processing library to tokenize self-evaluation comments, remove stop words, and detect occurrences of predetermined keywords that represent skills, strengths, or behavioral attributes. The server generates feature vectors that represent, for each project, counts or binary flags for each predetermined keyword, normalized work time statistics, goal-achievement ratios, and role encodings.

The server uses the internal summary generation module to assemble internal evaluation summary information from the evaluation feature information. The internal summary stores, for each evaluation target and work unit, a compact representation including identifiers, role information, work time aggregates, computed goal achievement indices, computed work efficiency indices, and extracted capability characteristic indicators. The server encodes this internal summary information as a structured record with defined fields, for example, a hierarchical key-value structure. The server preserves links from this internal summary to the underlying raw data by storing foreign keys or pointers so that subsequent auditing is possible.

The server uses the prompt generation module to convert the internal evaluation summary information into a natural-language prompt sentence suitable for input to the generative AI model. The server uses a template-based algorithm in which the internal summary fields are mapped to sentence fragments, and conditional rules determine which fragments are included and in what order. The server selects language patterns from a template repository such that the generated prompt sentence explicitly states the evaluation period, the projects, the roles, the goals and their actual values, and any notable deviations. The server additionally incorporates instruction information into the prompt sentence that specifies desired evaluation viewpoints, such as comparison between planned and actual performance, assessment of strengths and weaknesses, and allocation of an overall rating on a numerical scale. The server also encodes requested output structure by including in the prompt sentence explicit instructions on how to format the response.

In one example, the server generates the following prompt sentence for the generative AI model:

“Employee ID: E1234

Evaluation period: 2025-01-01 to 2025-03-31

Project: Project X

Role: backend engineer

Total hours: 120

Main tasks: implementing REST APIs, optimizing database queries, writing automated tests.

Self-evaluation comment:

‘I significantly improved the API response time, collaborated closely with the frontend team, and helped reduce critical bugs before release.’

Initial goals and results:
1) Reduce average API response time by 30% (actual improvement: 35%).
2) Achieve test coverage of at least 85% (actual coverage: 88%).
3) Deliver all core features by the release deadline (actual delivery: completed on time, with 2 minor features postponed).

Using the information above, act as a professional HR performance reviewer.

Evaluate this employee's performance on Project X.

Assess:
The degree of achievement for each initial goal,
Overall work efficiency and impact on the project,
Key strengths demonstrated,
Specific areas for improvement,
An overall performance rating on a 1-5 scale with a brief justification.

Provide the answer in English.

First, output a short narrative summary (3-5 sentences).

Then output a structured explanation with clearly separated sections for: ‘summary’, ‘goal evaluation’, ‘efficiency’, ‘strengths’, ‘improvement points’, and ‘overall rating’.”

The server transmits this prompt sentence to the generative AI invocation module, which interfaces with a generative AI model. In one embodiment, the server uses a transformer-based language model that has been pre-trained on a large corpus and optionally fine-tuned on domain-specific evaluation texts. The model architecture includes a plurality of self-attention layers, each layer including multi-head attention mechanisms and position-wise feed-forward networks. The model maintains token embeddings, positional encodings, and learned parameters that map sequences of tokens to probability distributions over output tokens.

The server sends the prompt sentence as a sequence of tokens to the generative AI model through an inference API. The generative AI model processes the prompt sentence by computing attention scores among tokens in the input using scaled dot-product attention, applying layer normalization and residual connections across layers, and propagating intermediate hidden states through the network. During inference, the model applies a decoding algorithm such as greedy decoding or beam search to generate the most likely continuation tokens while respecting constraints encoded in the prompt sentence.

The server configures the generative AI model with specific inference parameters such as temperature, top-k or top-p thresholds, and maximum output length. The server may supply additional control tokens or special separators to guide the model toward emitting well-structured sections that correspond to the requested summary and evaluation items. The server leverages these structured instructions in the prompt sentence so that the model's generative process is constrained to produce output that contains distinct sections for summary information, goal evaluation, efficiency, strengths, improvement points, and overall rating.

The server uses the result parsing and structuring module to receive the generated output from the generative AI model and to convert the free-form text into structured evaluation result information. The server searches for headings or markers that correspond to the requested sections and uses pattern-matching logic to segment the text. The server extracts numerical values corresponding to ratings or scores by applying regular expressions and numeric parsing functions. The server maps the extracted segments to fields in the evaluation result information record, which is stored in the storage device in association with the relevant internal evaluation summary information and evaluation feature information.

The server uses the user interaction management module to transmit the evaluation result information to the terminal. The terminal renders the result information on the display in a layout that shows, for example, an overview rating, a narrative summary, and separate sections for strengths and areas for improvement. The user uses the terminal to review the evaluation result information and, where appropriate, the user provides additional comments or corrections. The terminal sends these user inputs back to the server, which stores them as additional information or correction information associated with the corresponding evaluation result information. The server thereby maintains integrated human resource evaluation information that combines machine-generated assessments with human-authored annotations.

The server implements the described processing pipeline in a way that improves the functioning of the computer system itself. The server defines explicit intermediate data structures, such as the evaluation feature information and the internal evaluation summary information, that are not present in conventional systems that merely store raw logs and human-written evaluations. Because the server uses these intermediate representations to compress, normalize, and index employee-related data, the server reduces the memory footprint and accelerates subsequent retrieval and re-evaluation operations. The server, for instance, can reuse previously computed internal summaries when only the evaluation period changes or when new goals are added, thereby reducing redundant computation and network calls to the generative AI model.

The server improves evaluation accuracy by enforcing a deterministic mapping from employee-related metrics to prompt sentences. Conventional systems that send loosely structured narratives to a generative AI model allow the model to implicitly infer context, which can lead to unstable or inconsistent outputs. In contrast, the server explicitly encodes numeric goal achievement indices, work efficiency indices, and capability indicators in the prompt sentence as clearly labeled items. This explicit encoding reduces ambiguity in the model's input, which in turn reduces the variance of the model's output across repeated evaluations and improves reproducibility.

The server also reduces communication and computation load by carefully controlling the length and structure of the prompt sentences. The server uses feature selection and keyword extraction to include only relevant information in the internal summary and discards noisy or redundant details before prompt generation. This reduces the number of tokens processed by the generative AI model, which shortens inference time and lowers network traffic. The server further groups related performance data per project and per evaluation period, which allows incremental updates of evaluations without regenerating prompts for unaffected projects.

The server applies non-conventional rules to align subjective and objective indicators before the generative AI model is invoked. For example, the server computes difference metrics between self-reported contributions and measured goal achievement indices, and encodes these difference metrics directly in the prompt sentence along with explicit instructions for comparison. Human evaluators traditionally perform such comparisons heuristically. By contrast, the server enforces a repeatable computational procedure that generates numeric discrepancy measures and requests the generative AI model to interpret them in context. This combination of numeric pre-processing and constrained prompt design yields evaluations that are both grounded in metrics and capable of nuanced natural-language explanation.

In another embodiment, the server hosts the generative AI model locally rather than accessing it through a remote service. In this case, the server includes one or more graphics processing units or specialized accelerators. The server deploys a transformer-based model on these accelerators and uses an inference engine optimized for parallel linear algebra operations. The server partitions the model's parameters across multiple accelerator devices and uses pipeline or tensor parallelism to accelerate the attention and feed-forward computations. The server also applies quantization of model weights to reduce memory bandwidth and latency. These hardware-aware optimizations contribute to faster inference responses, thereby enabling near real-time evaluation for interactive use by the user.

In yet another embodiment, the server trains or fine-tunes the generative AI model using a dataset of historical evaluations. The server prepares a training corpus in which each sample includes a structured internal evaluation summary and a corresponding target evaluation text authored by human reviewers. The server converts each internal summary into a prompt sentence and trains the model to minimize a loss function such as cross-entropy between the model's generated tokens and the target tokens. The server uses backpropagation to compute gradients of the loss with respect to the model's parameters and uses an optimization algorithm such as stochastic gradient descent with adaptive learning rates to update the parameters. The server may apply data augmentation techniques, such as synonym substitution or reordering of non-essential sections in the prompt sentence, to increase robustness. This training process results in a generative AI model that is adapted specifically to the structure and style imposed by the internal summary and prompt generation pipeline, thereby improving alignment between the model's outputs and the system's evaluation objectives.

In still another embodiment, the server supports alternative feature extraction schemes that emphasize different technical performance aspects. For example, the server may compute temporal patterns of workload, such as bursts of high work time near project deadlines, and model these patterns using time-series features. The server may also compute statistics of comment sentiment using a separate sentiment analysis model and encode these statistics as additional fields in the internal evaluation summary. The server can then alter the prompt template to instruct the generative AI model to consider these temporal and sentiment features when generating its evaluation. Because these features are derived using explicit algorithms and are embedded in a structured representation, the underlying computation remains transparent and auditable.

The terminal can vary in implementation. For instance, one terminal may be a web browser running JavaScript, which communicates with the server using a RESTful API over HTTPS. Another terminal may be a native mobile application. In both cases, the terminal receives structured evaluation result information and renders it using a graphical user interface. The user interacts with the terminal to filter evaluations by period or project, to approve or reject AI-generated recommendations, and to append qualitative comments. The server processes these interactions not as mere free-form additions, but as structured annotations tied to specific fields in the evaluation result information. This structured annotation mechanism enables the server to learn from human edits and potentially adjust future prompt generation strategies.

Through these embodiments, the server does more than automate a human evaluation process. The server defines specific data structures (evaluation feature information, internal evaluation summary information, evaluation result information), specific transformation algorithms (normalization, keyword extraction, discrepancy calculation), and specific prompt construction rules that together improve the technical performance of the computer system. The improvements include faster and more efficient use of generative AI resources, increased reproducibility and stability of outputs, reduced storage and communication overhead, and enhanced traceability between raw data, model inputs, and model outputs. The server thereby provides a concrete technical implementation that integrates a generative AI model within a structured data processing pipeline, resulting in a system that materially improves computer-based processing of complex, heterogeneous evaluation data.

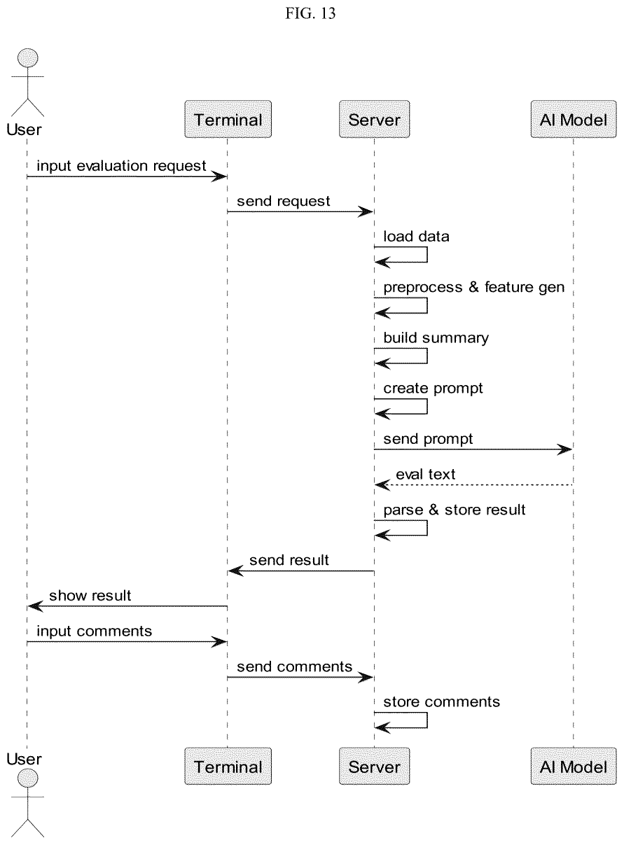

The following describes the processing flow using FIG. 13.

Step 1:

The user operates the terminal to issue an evaluation request.

The terminal displays an input screen including fields for employee identifier, evaluation period, project identifiers, and evaluation mode.

Input: user-entered employee identifier, evaluation period, and optional project list.

The terminal validates that required fields are not empty, formats the data into a request message, and sends an HTTPS request to the server.

Output: evaluation request information transmitted to the server.

Step 2:

The server receives the evaluation request information from the terminal via the network interface.

Input: evaluation request information containing employee identifier, evaluation period, and optional project identifiers.

The server parses the request, checks syntax and type validity, and verifies the identifiers against master tables in the database.

The server rejects invalid identifiers, returns an error response to the terminal in such cases, and logs the event.

Output: validated evaluation request parameters held in server memory, or an error message sent to the terminal.

Step 3:

The server acquires raw employee-related data from the storage device based on the validated request parameters.

Input: employee identifier, evaluation period, and optional project identifiers.

The server executes database queries to retrieve self-evaluation records, schedule records, work performance records, goal records, and attribute records that match the identifiers and fall within the specified period.

The server aggregates these query results into in-memory structures such as lists or dictionaries grouped by project and date.

Output: raw data bundle consisting of self-evaluation information, behavior schedule information, work performance information, goal information, and attribute information.

Step 4:

The server filters and normalizes the raw data bundle.

Input: raw data bundle.

The server removes records outside the evaluation period, discards unused fields such as debug flags, and eliminates duplicate entries by checking primary keys and timestamps.

The server converts time units (for example, minutes to hours), aggregates daily work records into per-project totals, and scales any numeric scores into a common range such as 0-100.

Output: cleaned and normalized data bundle containing only relevant and consistent records.

Step 5:

The server extracts linguistic and categorical features from text fields.

Input: cleaned and normalized data bundle including self-evaluation comments and textual descriptions of tasks.

The server tokenizes text, removes stop words, and applies keyword matching to detect predetermined terms representing skills, strengths, and behavioral traits.

The server maps detected keywords to capability categories and counts occurrences per project and per period.

Output: feature-augmented data bundle containing keyword counts and capability category indicators associated with each project and role.

Step 6:

The server generates evaluation feature information for each work unit.

Input: feature-augmented data bundle.

The server constructs evaluation feature records that include participation task information, work time information, role information, goal definitions, and preliminary goal achievement information for each project or work unit.

The server encodes each record as a structured object with defined fields and associates it with the corresponding employee identifier and project identifier.

Output: evaluation feature information set organized per employee and per project.

Step 7:

The server computes goal achievement indices and work efficiency indices.

Input: evaluation feature information set and goal information.

The server calculates ratios such as achieved_value/target_value for each goal, computes deviations from deadlines using date arithmetic, and derives efficiency measures such as completed tasks per hour.

The server stores these computed values in the feature records as numeric indices with explicit labels.

Output: enriched evaluation feature information including goal achievement indices and work efficiency indices.

Step 8:

The server generates internal evaluation summary information.

Input: enriched evaluation feature information.

The server aggregates per-project metrics, roles, capability indicators, and discrepancy measures between planned and actual work into compact summary records for each evaluation target.

The server constructs internal summaries that reference the underlying feature records via identifiers and store them in memory or in a dedicated summary table.

Output: internal evaluation summary information for each evaluation target and work unit.

Step 9:

The server constructs a prompt sentence for the generative AI model.

Input: internal evaluation summary information.

The server applies a template-based algorithm to insert summary fields such as project names, roles, total hours, initial goals, actual results, and computed indices into predefined sentence patterns.

The server appends instruction segments that specify evaluation viewpoints, required assessment items, and desired output structure.

Output: natural-language prompt sentence tailored to the specific evaluation target and period.

Step 10:

The server transmits the prompt sentence to the generative AI model and requests inference.

Input: prompt sentence and model configuration parameters such as temperature, maximum output length, and decoding strategy.

The server formats the prompt sentence as a sequence of tokens, constructs an API request or internal inference call, and sends the request to the generative AI model hosted locally or remotely.

The server waits for the model to complete attention computations and decoding and then receives the generated text response.

Output: model-generated evaluation text corresponding to the prompt sentence.

Step 11:

The server parses and structures the model-generated evaluation text.

Input: model-generated evaluation text.

The server scans the text for section headings and markers (for example, “summary”, “goal evaluation”, “efficiency”, “strengths”, “improvement points”, “overall rating”) and splits the text into segments.

The server applies pattern matching and numeric parsing to extract ratings, lists of strengths, and descriptions of improvement areas and maps them into corresponding fields in a structured record.

Output: structured evaluation result information containing summary information, strength information, improvement-required information, and comprehensive evaluation indices.

Step 12:

The server stores the structured evaluation result information in the storage device.

Input: structured evaluation result information and associated internal evaluation summary information identifiers.

The server writes records into an evaluation result table, including references to the employee identifier, project identifiers, internal summary identifiers, and model metadata such as model version and timestamp.

The server commits the transaction to ensure persistence and updates any indexes needed for fast retrieval.

Output: persistent evaluation result records stored in the database and ready for retrieval.

Step 13:

The server prepares response data for the terminal.

Input: evaluation result records and user role information.

The server formats the evaluation results into a response object, selecting visible fields according to access control rules, and organizes sections for overview rating, detailed per-project evaluation, strengths, and improvement points.

The server serializes this object into a network response format and sends it to the terminal over HTTPS.

Output: response message containing formatted evaluation result data transmitted to the terminal.

Step 14:

The terminal receives and displays the evaluation result data.

Input: response message containing formatted evaluation result data.

The terminal parses the message, constructs user interface elements such as summary panels, tables, and text areas, and renders them on the display.

The terminal highlights key metrics, shows the narrative evaluation generated from the generative AI model, and provides interactive controls for adding comments or confirming the evaluation.

Output: visual presentation of evaluation results on the terminal screen.

Step 15:

The user reviews the evaluation results and optionally provides annotations.

Input: displayed evaluation results.

The user reads the summary, inspects project-level details, and, if necessary, enters additional comments or corrections using the input device of the terminal.

The user confirms submission of the annotations through a control such as a button or menu item.

Output: user-generated annotation data prepared for transmission to the server.

Step 16:

The terminal transmits user annotations to the server.

Input: user-generated annotation data and identifiers of the corresponding evaluation result records.

The terminal packages the annotations into a request message and sends the message to the server via HTTPS.

The terminal waits for an acknowledgment and may update the display to reflect that the annotations have been submitted.

Output: annotation request message delivered to the server.

Step 17:

The server stores and links user annotations with the evaluation results.

Input: annotation request message containing annotation data and evaluation result identifiers.

The server validates the identifiers, creates annotation records in an annotation table, and associates each annotation with the corresponding evaluation result through foreign keys.

The server updates any summary indicators that reflect the presence of human annotations and commits the transaction.

Output: updated database state in which evaluation result information and human annotation information are persistently linked.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented performance evaluation systems for workers, employees, and industrial equipment typically rely on fixed scoring rules, pre-defined numerical indicators, or simple statistical aggregation of sensor data and self-reported information. In such systems, a processor generally computes evaluation scores by applying static formulas to stored metrics, without making effective use of rich natural-language descriptions, contextual project information, or emotional state information of the evaluated subject. As a result, the system often fails to capture nuanced relationships between qualitative self-evaluation text, heterogeneous operational data, and environmental conditions, which leads to evaluations that are either overly simplistic, inconsistent across use cases, or not adaptable to changing operational contexts.

Furthermore, in many existing architectures, a generative artificial intelligence model, if used at all, is invoked in an ad-hoc manner, for example by allowing a human operator to manually craft prompts and manually interpret free-form responses. In these cases, the system does not systematically generate prompt sentences from structured data, does not integrate the model's outputs back into the machine-readable data pipeline, and does not coordinate generative AI inference with separate emotion analysis components. Consequently, the overall computing system cannot reliably automate evaluation at scale, cannot guarantee reproducible behavior, and cannot efficiently utilize heterogeneous computing resources such as external AI inference services and sentiment analysis engines.

In addition, existing systems generally treat emotion or sentiment analysis, when present, as an afterthought, separate from the core computation of performance scores. Emotion analysis outputs are rarely combined in a defined, machine-interpretable way with the numerical evaluation results, and thus cannot systematically adjust or refine those results. This means that the processor cannot take advantage of emotional state indicators to improve robustness of evaluation in cases of extreme stress, over-confidence, or under-confidence, and cannot tailor generated guidance or feedback text to the subject's state in a repeatable, algorithmic manner.

From a computer technology standpoint, the lack of an integrated processing pipeline that automatically (i) acquires heterogeneous evaluation target information, (ii) integrates it with external data sources, (iii) dynamically generates structured prompt sentences, (iv) invokes a generative AI model as a computational component within the pipeline, (v) coordinates the output with an emotion analysis engine, and (vi) stores and presents unified evaluation results, leads to several technical problems. These problems include increased processing latency due to manual steps, higher error rates in data interpretation and mapping between textual and numerical domains, poor scalability when the number of evaluated subjects or devices increases, and difficulty in verifying or reproducing evaluation outcomes across systems or over time.

Accordingly, there is a need for a computer-implemented system that improves the way a processor acquires, structures, and processes evaluation data by using a generative artificial intelligence model in combination with an emotion analysis engine. More specifically, there is a need for a system in which the processor is configured to automatically construct prompt sentences in a natural language from integrated evaluation data, to submit the prompt sentences to a generative AI model, to convert the model's response into structured performance evaluation information, and to algorithmically combine that information with emotional state information, thereby improving the technical performance of the evaluation pipeline in terms of automation, robustness, scalability, and reproducibility.

The specific processing by the specific processing unit 290 of the data processing device 12 in Application Example 2 is realized by the following means.

The present invention provides a server comprising a processor configured to acquire evaluation target information including self-evaluation information and work plan information via an input device, to generate integrated evaluation data by integrating the evaluation target information with externally acquired information stored in one or more storage devices, to generate a prompt sentence in a natural language based on the integrated evaluation data, to input the prompt sentence as input data to a generative artificial intelligence model and obtain performance evaluation information from the generative artificial intelligence model, to input text data included in the self-evaluation information or in the evaluation target information to an emotion analysis engine and obtain emotional state information, to generate evaluation result information by using both the performance evaluation information and the emotional state information, to store the evaluation result information in the storage device in a structured, machine-readable format, and to present the evaluation result information to a user terminal via an output device or a communication device. This enables the underlying computer system to automatically and consistently transform heterogeneous raw evaluation data into unified evaluation results through a coordinated pipeline that combines generative AI inference and emotion analysis, thereby improving the technical efficiency, scalability, and reliability of performance evaluation processing implemented by the server.

The term “processor” refers to a hardware computing element or a combination of hardware computing elements that executes instructions to perform data acquisition, data processing, control, and communication operations in the system.

The term “input device” refers to any hardware or software interface through which evaluation target information is entered into the system, including but not limited to keyboards, pointing devices, touch panels, microphones, and network-based input interfaces.

The term “output device” refers to any hardware or software interface that presents information from the system to a user, including but not limited to display units, printers, speakers, and graphical user interfaces rendered on terminals.

The term “communication device” refers to a hardware or software communication interface that enables data exchange between the server and external devices or services, including but not limited to network interface controllers, wireless communication modules, and communication protocol stacks.

The term “storage device” refers to any computer-readable medium used to store data or programs, including but not limited to semiconductor memory, magnetic storage, optical storage, and network-accessible storage resources.

The term “evaluation target information” refers to information related to a subject or device to be evaluated, including at least self-evaluation information, work plan information, and other descriptive or quantitative data associated with evaluation.

The term “self-evaluation information” refers to information representing an evaluation made by a subject regarding the subject's own performance, efficiency, or contribution, including at least natural-language comments and optionally numerical self-ratings.

The term “work plan information” refers to information describing planned tasks, schedules, or work allocations for a subject or device, including at least planned working hours, planned tasks, milestones, and related schedule data.

The term “externally acquired information” refers to information obtained by the processor from sources other than direct user input of evaluation target information, including but not limited to calendar information, project information systems, sensor data, and environmental monitoring systems.

The term “integrated evaluation data” refers to data generated by combining evaluation target information with externally acquired information into a unified, structured representation suitable for subsequent analysis.

The term “prompt sentence” refers to a natural-language expression generated by the processor based on integrated evaluation data and supplied as input content to a generative artificial intelligence model to cause the model to perform a desired processing task.

The term “generative artificial intelligence model” refers to a machine-implemented model that receives input data including at least one prompt sentence and generates output data by performing statistical or neural network based inference, including generation of evaluation, classification, or explanatory information.

The term “performance evaluation information” refers to information output from the generative artificial intelligence model that quantitatively or qualitatively represents an evaluation of performance, efficiency, or contribution of a subject or device.

The term “emotion analysis engine” refers to a machine-implemented component that analyzes text data or other data and outputs information representing an estimated emotional or affective state, including at least polarity, intensity, or categories of emotions.

The term “emotional state information” refers to information output from the emotion analysis engine that indicates an inferred emotional state of a subject, such as stress, confidence, satisfaction, or fatigue, in an interpretable form for subsequent processing.

The term “evaluation result information” refers to information generated by the processor using at least the performance evaluation information and the emotional state information, and representing a final or intermediate result of an evaluation process in a structured format.

The term “user terminal” refers to an information processing apparatus separate from the server, including but not limited to a personal computer, a mobile terminal, or an industrial terminal, that communicates with the server to send input and receive presentation of evaluation result information.

The term “project information” refers to information describing one or more projects associated with a subject or device, including at least project identifiers, objectives, progress, and related contextual data.

The term “time information” refers to information representing temporal aspects of work or operation, including at least working hours, operation times, idle times, and scheduling times.

The term “subject characteristic information” refers to information describing attributes of a subject to be evaluated, including at least skills, experience, roles, and other characteristics relevant to performance evaluation.

The term “equipment operation information” refers to information describing operational behavior of equipment or devices, including at least operation status, operation time, output quantity, fault occurrence, and similar operational metrics.

The term “environment information” refers to information describing conditions in an environment in which a subject or device operates, including at least temperature, humidity, vibration, noise level, or other environmental parameters.

The term “efficiency” refers to a quantitative or qualitative measure of how effectively a subject or device performs work or operation relative to resources or time consumed.

The term “contribution” refers to a quantitative or qualitative measure of the degree to which a subject or device contributes to achieving one or more goals, tasks, or project outcomes.

In one embodiment, a server implements the claimed system as a networked computer system that cooperates with one or more terminals operated by users. The server includes at least one processor, a main memory, a non-volatile storage device, and a network interface. The terminal includes at least a display device, an input device such as a keyboard or touch panel, and a communication interface. The server executes computer programs that cause the processor to perform the functions described below.

Server operates as a central evaluation engine that acquires evaluation target information, generates integrated evaluation data, constructs a prompt sentence, invokes a generative AI model, invokes an emotion analysis engine, and stores and presents evaluation result information. Terminal operates as an input/output device through which a user supplies self-evaluation information and work plan information and receives evaluation result information.

Server uses general-purpose hardware, such as a multi-core central processing unit and optionally a graphics processing unit, and runs an operating system such as a general-purpose server operating system. Server executes application software developed in a programming language such as Python or another high-level language. Server may use a relational database management system such as a general relational database, a web application framework such as a general web framework, and client-side frameworks at the terminal such as a general web UI framework, but the invention is not limited to specific products.

Server acquires evaluation target information by receiving, via a communication device, form data transmitted from the terminal. User enters, at the terminal, self-evaluation information including natural-language comments such as “I worked 8 hours on Project X and I believe my contribution was high,” and work plan information including planned tasks and planned working hours. Terminal sends these inputs over a secure network connection to the server. Server stores the received information as structured records in the storage device. In one concrete structure, server stores fields such as subject identifier, project identifier, actual working hours, planned working hours, self-evaluation text, and time stamps.

Server further acquires externally obtained information by querying external services or internal subsystems. Server may retrieve calendar data from a scheduling service, retrieve project information from a project management system, and retrieve equipment operation information from sensors connected to industrial apparatus such as programmable logic controllers or embedded microcontrollers. Server stores these data in tables that are keyed by subject identifier, project identifier, device identifier, and date.

Server generates integrated evaluation data by joining and aggregating these heterogeneous data sources into a unified data structure. In one embodiment, server uses an internal data representation in which each evaluation case includes: project information (such as project name, target values, and progress rate), time information (such as actual working hours and operation time), subject characteristic information (such as skill level and role), equipment operation information (such as throughput, downtime, and error counts), and environment information (such as temperature and vibration). Server computes derived features such as actual-to-planned time ratio, output per hour, deviation from target, and normalized environmental stress indices.

Server generates a prompt sentence based on the integrated evaluation data. Server applies a deterministic formatting algorithm that maps specific fields of the integrated evaluation data to specific segments of a natural-language text template. For example, server generates a prompt sentence of the following form:

“Employee A worked 100 hours on Project X. The planned hours were 90. The self-evaluation comment is: ‘My contribution was high.’ Project X achieved 110 percent of its target. Based on this information, evaluate Employee A's performance and contribution on a scale from 0 to 100 and provide three strengths and two improvement points. Output the result in a clearly structured textual format.”

In another embodiment, server generates a prompt sentence for equipment or machine evaluation, for example:

“Machine A operated for 8 hours, produced 480 units, and experienced 2 short stoppages. The operator's comment is: ‘The work proceeded efficiently, but there were brief interruptions.’ The production target was 450 units. Based on this information and considering efficiency and stability, evaluate the performance score of Machine A from 0 to 1 and describe the reasons.”

Server uses a generative AI model as a computational component to infer performance evaluation information from the prompt sentence. In one embodiment, the generative AI model is implemented as a transformer-based neural network that has been pre-trained on a large corpus and fine-tuned on evaluation-related data. The model includes multiple self-attention layers, feed-forward networks, and layer normalization components. The model uses token embeddings, positional encodings, and multi-head attention to process the prompt sentence. During training, the model minimizes a loss function such as a cross-entropy loss for predicting next tokens and may be further fine-tuned using reinforcement learning from human feedback to align outputs with evaluation tasks. Weight parameters of the neural network are updated by gradient descent using an optimizer such as an adaptive optimization algorithm.

Server encodes the prompt sentence into token sequences according to a predefined vocabulary and transmits these sequences to the generative AI model via an application programming interface. The model performs numerical operations including matrix multiplications and non-linear activations to compute output token probabilities and generates an output sequence that includes performance evaluation information. Server receives the generated output text and applies a parsing algorithm that detects predefined markers or patterns to extract numerical scores, categorical levels, and lists of strengths and improvement points. By formalizing the mapping from structured data to prompt sentence and from generated text back to structured evaluation information, the system ensures reproducibility and machine-readability of results.

Server also uses an emotion analysis engine to obtain emotional state information. In one embodiment, the emotion analysis engine is implemented as a separate neural network that receives natural-language text and outputs emotion labels and confidence scores. The engine may use a recurrent neural network or transformer architecture and may be trained on corpora labeled with emotion categories such as “stress,” “confidence,” “satisfaction,” and “fatigue.” Server supplies self-evaluation text or related comments to the emotion analysis engine and receives numerical emotion scores. Server then stores these emotion scores as part of the integrated evaluation data.

Server generates evaluation result information by algorithmically combining performance evaluation information from the generative AI model with emotional state information from the emotion analysis engine. In one embodiment, server applies a set of rule-based adjustments and weighted aggregation functions. For example, server may reduce the recommended workload in subsequent guidance if performance is high and stress is also high, or may increase emphasis on encouragement in generated feedback if confidence is low while performance is moderate. Server may compute a final evaluation score as a weighted sum of the raw performance score and a term that depends on emotion scores, using predetermined or adaptively learned weights. This combination is performed according to explicit parameters stored in configuration data, which allows consistent behavior across evaluations and across deployments.

Server stores evaluation result information in the storage device in a structured format that includes at least: the final performance score, efficiency indicators, contribution indicators, strengths, improvement points, and emotion summaries. By storing evaluation result information as structured records, server supports efficient querying, aggregation, and historical analysis. This internal representation also enables additional algorithmic operations such as anomaly detection and trend analysis.

Server presents evaluation result information to the terminal through a communication device. Terminal receives the evaluation result information and renders it on a display device as graphical charts, tables, and textual explanations. User can view, for example, a bar graph of performance scores over time, a list of strengths and improvement points, and aggregated emotion trends. In industrial settings, server may also send evaluation result information to control systems that manage maintenance schedules or machine configuration. For example, if the performance score of a machine decreases while environmental stress indicators remain high, server may send a maintenance request or adjust operation parameters through an industrial control interface.

In one concrete example, user at a factory terminal inputs that Machine A assembled 100 parts in 1 hour and adds a comment: “The machine operated smoothly with minor delays at the start.” Server retrieves sensor data showing that Machine A experienced short initial downtime and that environmental temperature was slightly elevated. Server generates integrated evaluation data including throughput, downtime patterns, and environment information, then generates a prompt sentence that describes these conditions. The generative AI model returns a performance score and textual explanation. The emotion analysis engine indicates a neutral to positive emotional state. Server combines these results to generate evaluation result information indicating that Machine A is efficient but may benefit from warm-up routines. Server stores this information and causes the terminal to display a recommendation to adjust startup procedures and schedule periodic checks.

In another example, user at an office terminal enters: “I worked 50 hours this month on the new planning project and I am not sure if my contribution was sufficient.” Server retrieves calendar data confirming meeting times and document editing sessions. Server generates integrated evaluation data and a prompt sentence that includes workload and project progress. The generative AI model produces a score and identifies strengths such as thorough documentation and coordination. The emotion analysis engine detects uncertainty and low confidence. Server uses this emotional state to adjust feedback, emphasizing positive aspects and suggesting specific ways to measure contribution. Server transmits this adjusted evaluation result to the terminal, where user sees both quantitative scores and context-aware guidance.

The described configuration provides technical effects beyond mere automation of human judgment. By representing heterogeneous evaluation data in a specific integrated data structure, by deterministically mapping that structure to a prompt sentence, by employing a generative AI model with defined neural architecture and training process as a computational inference component, and by combining its output with explicit emotion scores in a rule-based and parameterized manner, server improves the internal operation of the computer system. In particular, server reduces errors associated with ad-hoc manual prompt creation, reduces latency by eliminating human-in-the-loop steps, and increases consistency of evaluations across large numbers of subjects or devices. Moreover, server improves data management by storing intermediate and final results in structured form that is directly linked to the prompt sentences and model outputs, which facilitates reproducibility and auditability. Server also improves computational efficiency by avoiding repeated fine-grained rule execution for each evaluation. Instead, server uses the generative AI model to encode complex relationships between textual descriptions and numerical metrics in the model's weights. During inference, the model performs matrix operations that are highly optimized on modern hardware accelerators. This results in higher throughput when many evaluations must be processed concurrently. Because the prompt sentence is generated automatically from integrated evaluation data, the system reduces communication payload and computational load on the generative AI model by including only relevant, pre-aggregated features rather than raw logs or unfiltered data streams.

The system further provides a technical improvement in communication load and robustness. Server may compress evaluation target information into more concise prompt sentences by synthesizing only salient features as determined by heuristics or previous model outputs. This reduces the total number of tokens transmitted to and from the generative AI model, which in turn reduces network bandwidth usage and response latency. Additionally, by structuring internal data around explicit fields and mappings, server can detect anomalies such as missing required segments in the model's response and can automatically re-issue prompts or apply fallback logic, thereby increasing robustness of the overall computing system.

In alternative embodiments, server may employ different neural network architectures for the generative AI model, such as encoder-decoder architectures or mixture-of-experts models, and may adapt training methods, including supervised fine-tuning on domain-specific evaluation logs, use of different loss functions like mean squared error for numeric targets, or use of data augmentation techniques that generate paraphrased self-evaluation texts. Server may also employ different emotion analysis engines, including models that combine text and audio features to achieve higher accuracy. Additionally, server may adjust combination rules between performance evaluation information and emotional state information based on adaptive algorithms that learn weighting factors from historical outcomes.

In some embodiments, server connects to industrial controllers to adjust machine parameters based on evaluation result information. For example, server may send updated speed limits, maintenance intervals, or operating modes over a fieldbus or industrial Ethernet link. In such embodiments, the improved accuracy and timeliness of evaluation result information directly contribute to reduced mechanical wear, lower energy consumption, and improved overall system uptime, thereby demonstrating a concrete technical effect in the physical world.

In summary, server, terminal, and user cooperate in a system in which the server's processor performs specifically structured data integration, natural-language prompt generation, generative AI inference, emotion analysis, and structured result generation. This configuration improves the functioning of the computing system itself by enabling faster, more accurate, and more scalable performance evaluation operations that are not achievable with conventional rule-based or manually driven systems.

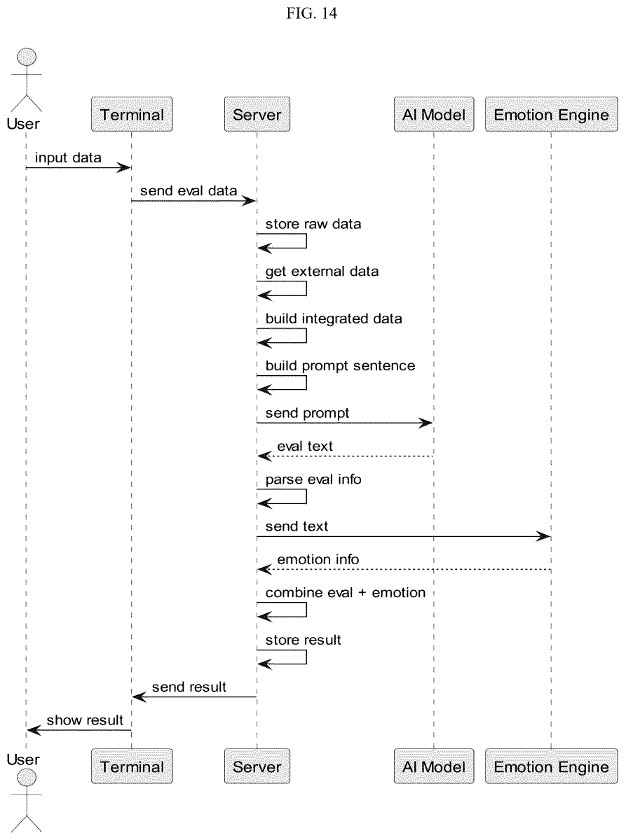

The following describes the processing flow using FIG. 14.

Step 1:

User inputs evaluation target information at the terminal.

User operates the terminal to enter self-evaluation information and work plan information into input fields of a graphical user interface. The input includes, for example, project name, planned working hours, actual working hours, task description, and a natural-language self-evaluation comment such as “I worked 8 hours on Project X and my contribution was high.”

Terminal packages these fields as structured data and transmits them to the server via a network connection.

Input: keystrokes or touch operations by the user.

Output: a structured data object transmitted to the server that contains at least subject identifier, project identifier, time information, and self-evaluation text.

Step 2:

Server receives and stores raw evaluation target information.

Server, executing a web application, receives the structured data object from the terminal through a communication interface. Server validates required fields, checks formats, and assigns a unique record identifier.

Server writes the validated data into a storage device, such as a relational database, using predefined table schemas.

Input: the structured data object sent from the terminal.

Output: a stored evaluation target record, including normalized fields for subject, project, time, and text, saved in the database.

Step 3:

Server acquires externally obtained information and links it to the evaluation target.

Server queries external or internal information sources, such as a scheduling service, a project management system, or equipment monitoring subsystems, using identifiers contained in the stored evaluation target record.

Server retrieves related calendar events, project status, machine operation logs, and environment measurements, then links these records to the evaluation target via subject identifier, project identifier, or time range.

Input: the evaluation target record and references (identifiers, dates) contained in that record.

Output: a set of external data records, including project information, additional time information, equipment operation information, and environment information associated with the evaluation target.

Step 4:

Server generates integrated evaluation data by combining heterogeneous records.

Server loads the evaluation target record and the associated external data records into working memory. Server aligns records by identifiers and time intervals and performs data cleaning operations such as type conversion, missing-value handling, and unit normalization.

Server computes derived features such as actual-to-planned time ratio, throughput per hour, deviation from project target, and environment stress indices by applying arithmetic operations and conditional logic.

Server assembles these original and derived values into a single integrated data structure that represents the complete context for the evaluation.

Input: the stored evaluation target record and the set of external data records.

Output: integrated evaluation data containing at least project information, time information, subject characteristic information, equipment operation information, environment information, and derived feature values.

Step 5:

Server constructs a prompt sentence from the integrated evaluation data.

Server executes a formatting module that maps specific fields of the integrated evaluation data to predefined segments of a natural-language template. Server inserts numerical values, project names, and self-evaluation text into the template, ensuring consistent ordering and phrasing.

For example, server generates a prompt sentence of the form:

“Employee A worked 100 hours on Project X. The planned hours were 90. The self-evaluation comment is: ‘My contribution was high.’ Project X achieved 110 percent of its target. Based on this information, evaluate Employee A's performance and contribution on a scale from 0 to 100 and provide three strengths and two improvement points. Output the result in a clearly structured textual format.”

Input: the integrated evaluation data.

Output: a prompt sentence in natural language that encodes the integrated evaluation data in a form suitable for processing by the generative AI model.

Step 6:

Server submits the prompt sentence to a generative AI model and obtains performance evaluation information.

Server converts the prompt sentence into a sequence of tokens according to the input specification of the generative AI model and sends the tokenized prompt to an inference service implementing a transformer-based neural network.

The generative AI model performs internal numerical operations, including matrix multiplications and non-linear activations across multiple attention layers, to generate an output sequence that contains performance evaluation information such as scores, strengths, and improvement points.

Server receives the generated text and parses it according to predefined patterns or markers, extracting numeric scores and labeled lists into a structured format.

Input: the prompt sentence generated from the integrated evaluation data.

Output: performance evaluation information comprising at least a performance score, efficiency or contribution indicators, and textual descriptions of strengths and improvement points, represented as structured data.

Step 7:

Server obtains emotional state information using an emotion analysis engine.

Server sends self-evaluation text or other relevant comments associated with the evaluation target to an emotion analysis engine via an appropriate interface. The engine applies a trained model to classify emotional categories and to assign intensity scores, such as stress level, confidence level, or satisfaction level.

Server receives the emotion output and converts it into standardized emotional state information, such as numerical scores on predefined scales.

Input: text data extracted from self-evaluation information or related records.

Output: emotional state information including one or more emotion categories and associated numerical intensities.

Step 8:

Server combines performance evaluation information and emotional state information to generate evaluation result information.

Server executes an aggregation module that takes the structured performance evaluation information and the emotional state information as inputs. Server applies explicit rules, such as adjusting recommended workload when both performance score and stress level are high, or emphasizing encouragement when confidence level is low but performance is moderate.

Server may compute a composite evaluation score by applying a weighted function that incorporates both performance and emotional factors. Server also generates final guidance text by combining original strengths and improvement points with adjustments derived from emotional state.

Input: performance evaluation information and emotional state information.

Output: evaluation result information containing final scores, qualitative assessments, and adjusted guidance, stored in a structured representation.

Step 9:

Server stores evaluation result information and associates it with the evaluation target.

Server writes the evaluation result information into the storage device in tables or records that are linked to the original evaluation target record via identifiers. Server maintains time stamps and version information to allow historical analysis and auditing.

Server may also log the prompt sentence and the generative AI model's raw response for traceability.

Input: the evaluation result information generated from combined performance and emotional data.

Output: persistent records of evaluation results and related metadata stored in the database for later retrieval and analysis.

Step 10:

Server transmits evaluation result information to the terminal for presentation.

Server selects relevant fields of the evaluation result information and formats them into a response message suitable for the terminal, including numeric scores, labels, and textual explanations. Server sends this response over the communication interface to the terminal.

Terminal receives the response and renders graphical elements such as score bars, trend lines, and lists of strengths and improvement points on a display device. Terminal may also show the underlying explanation text generated from the evaluation result information.

Input: evaluation result information retrieved from the storage device.

Output: a displayed evaluation view on the terminal that presents the final evaluation to the user.

Step 11:

User reviews the evaluation and optionally provides follow-up input.

User views the scores, explanations, and guidance on the terminal display and interprets the evaluation result information. User may acknowledge the evaluation, request further detail, or enter follow-up comments or updated self-evaluation.

Terminal captures this follow-up input and, if provided, transmits it back to the server, where it may be recorded as additional evaluation target information or used to refine subsequent evaluations.

Input: visual presentation of evaluation result information to the user.

Output: user confirmation, behavioral changes in the real-world operation, or new input that can be incorporated into future evaluation cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

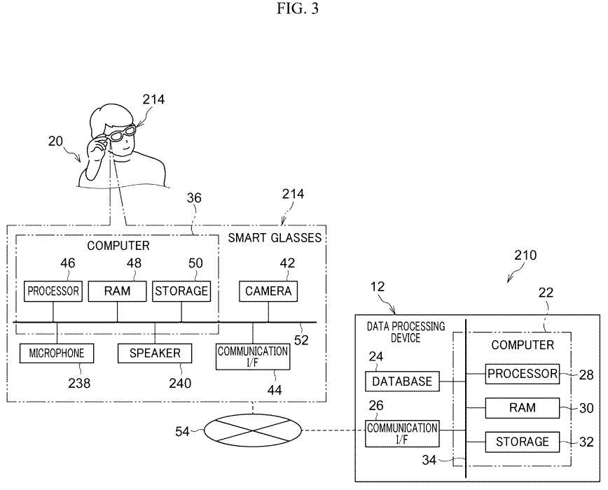

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

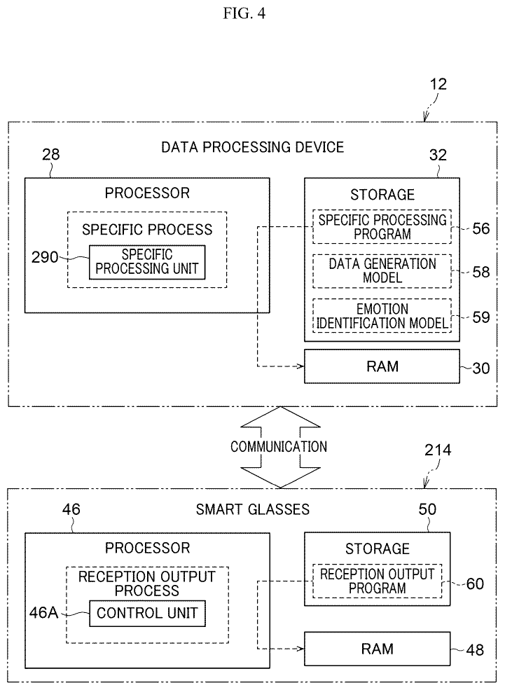

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

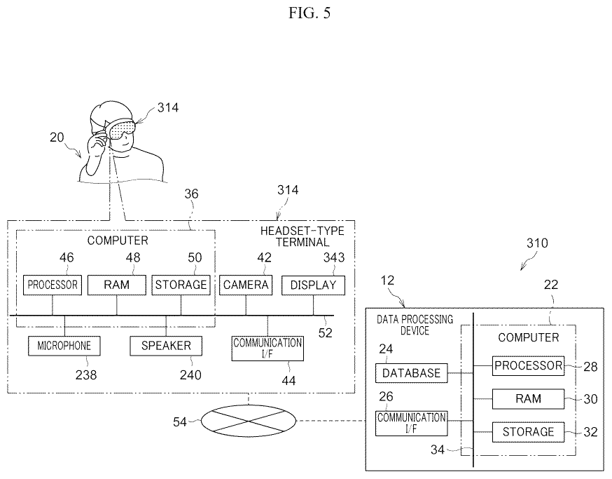

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

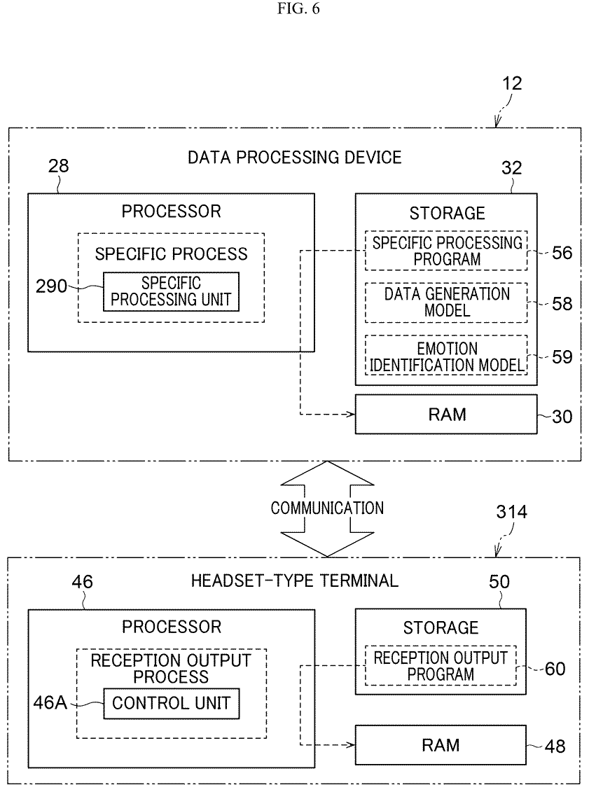

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

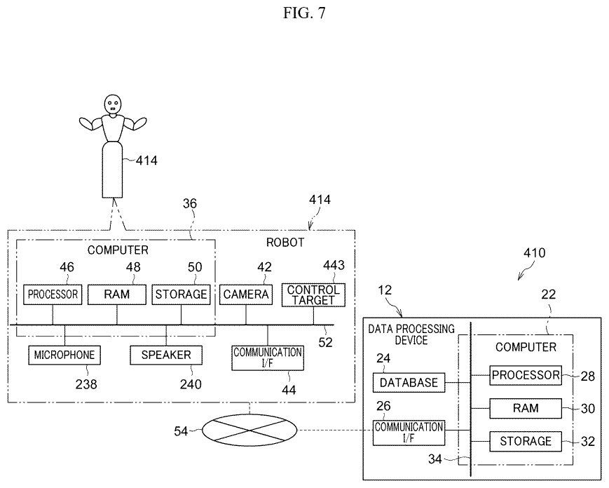

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

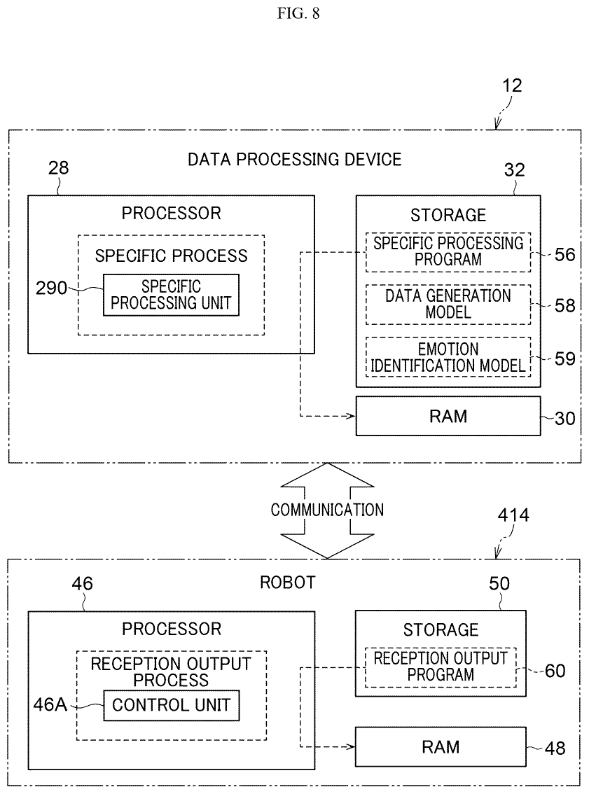

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

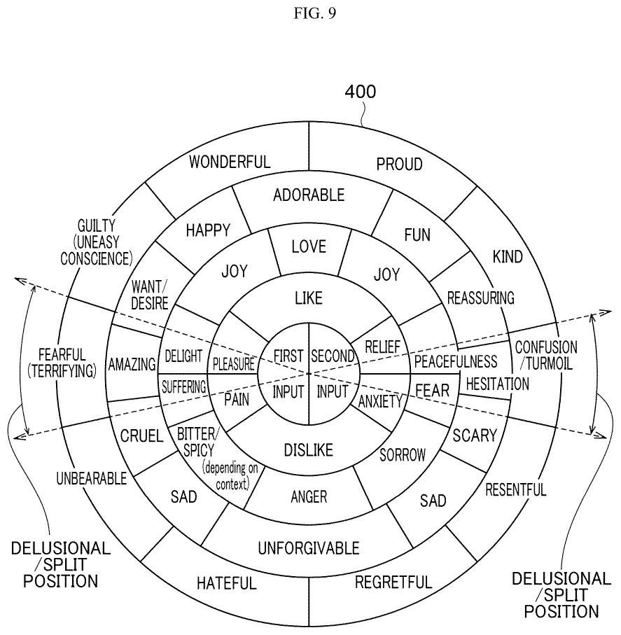

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

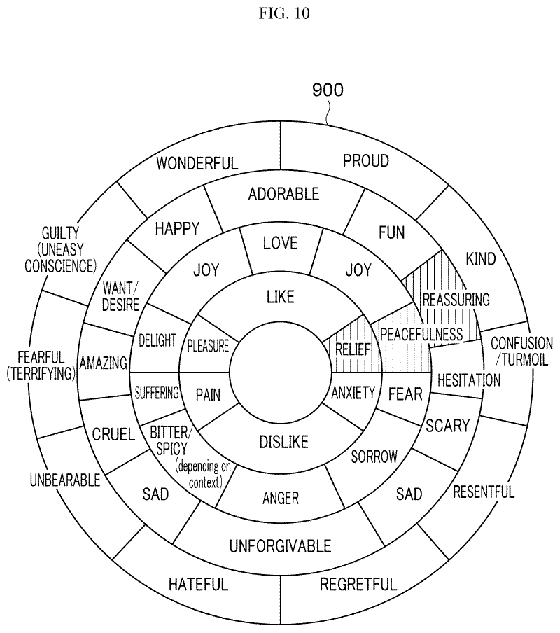

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

receive self-evaluation information of an evaluation target from a terminal and store the self-evaluation information in a storage device,

generate a prompt sentence including natural language text comprising the self-evaluation information as input information, request an analysis process by a generative AI model using the prompt sentence, extract evaluation feature information from the self-evaluation information based on an analysis result acquired from the generative AI model, and store the evaluation feature information as intermediate data in the storage device,

communicate with an external time management system serving as an external information source to acquire time management information of the evaluation target and store the acquired time management information in the storage device,

integrate the evaluation feature information and the time management information, apply an evaluation algorithm to an integration result, and generate evaluation result data regarding a work performance state of the evaluation target,

generate a prompt sentence including structured data comprising the evaluation result data as input information, request generation of a natural language feedback text by the generative AI model using the prompt sentence, acquire the natural language feedback text from the generative AI model, and store the natural language feedback text in association with the evaluation result data in the storage device, and

transmit the evaluation result data and the natural language feedback text to the terminal so that the terminal displays the evaluation result data and the natural language feedback text.

### (Supplementary 2)

The system according to supplementary 1,

wherein the processor is configured to automatically execute extraction of the evaluation feature information and acquisition of the time management information, and automatically generate the evaluation result data by using the evaluation algorithm so as to reduce processing time required for evaluation of work efficiency of the evaluation target.

### (Supplementary 3)

The system according to supplementary 1,

wherein the processor is configured to execute the evaluation algorithm by using, as the evaluation feature information, feature quantities corresponding to a plurality of evaluation categories, and by using, as the time management information, a plurality of work activity indices, so as to determine the evaluation of the work efficiency of the evaluation target in a multifaceted and comprehensive manner.

### Application Example 1

### (Supplementary 1)

A system comprising a processor,

wherein the processor is configured to

acquire, from an information processing apparatus, a plurality of types of work-related information including self-evaluation-related information and work-plan-related information regarding workers, and facility-operation-related information,

analyze the work-related information to organize task-unit information, work-time-related information, worker-characteristic-related information, and facility-operation-related information,

collect, as the facility-operation-related information, operation-history information and work-time information acquired from detection devices provided in production facilities, structure the operation-history information and the work-time information, and store the structured information in a storage area,

execute, by using data-analysis software, preprocessing on the operation-history information and the work-time information stored in the storage area, the preprocessing including missing-value correction, duplicate removal, time-information normalization, and aggregation processing, and generate a performance-evaluation data set on a per-facility basis,

convert the performance-evaluation data set into a predetermined data format, embed the converted performance-evaluation data set into a prompt sentence, transmit, as analysis request information, the prompt sentence to an information-processing infrastructure that operates a generative AI model, and acquire, from the generative AI model, a performance-evaluation result and efficiency-improvement-proposal information,

associate and store the performance-evaluation result and the efficiency-improvement-proposal information with the task-unit information, the work-time-related information, and the worker-characteristic-related information, and convert the associated information into display data,

analyze, by using an analysis engine having an emotion-analysis function, the self-evaluation-related information to grasp an emotional state of the worker, and adjust the performance-evaluation result and an evaluation result with respect to the worker based on the emotional state,

transmit the display data including the performance-evaluation result, the efficiency-improvement-proposal information, and the adjusted evaluation result to a terminal device having a display device, and cause a display screen of the terminal device to display, in a comparative manner, work efficiency of the production facilities and work efficiency of the workers, and

in response to an operation by a user, retransmit to the generative AI model a prompt sentence input from the terminal device and at least a part of the display data, and acquire additional proposal information or additional analysis results from the generative AI model.

### (Supplementary 2)

The system according to supplementary 1,

wherein the processor is configured to

dynamically generate and transmit to the generative AI model the prompt sentence that includes the performance-evaluation data set comprising operation indicators, utilization indicators, downtime-ratio indicators for each production facility, and work-efficiency indicators for each worker, thereby automating work-efficiency evaluation of the production facilities and the workers and reducing time required for the evaluation.

### (Supplementary 3)

The system according to supplementary 1,

wherein the processor is configured to

use, in combination, the efficiency-improvement-proposal information acquired from the generative AI model, the emotional state grasped by the analysis engine having the emotion-analysis function, and the work-time-related information, to perform a comprehensive work-efficiency evaluation that takes into account both an operation state of the production facilities and a state of the workers, thereby improving efficiency and accuracy of the evaluation.

### Example 2

### (Supplementary 1)

A system comprising a processor,

wherein the processor is configured to operate as a generative information processing unit; wherein the processor is configured to acquire, from a user terminal, evaluation request information including an identification of an evaluation target and a period to be evaluated, and, based on the identification and the period, to acquire, from a storage device, self-evaluation information, behavior schedule information, work performance information, goal information, and attribute information related to the evaluation target;

wherein the processor is configured to remove unnecessary information from the acquired information, to normalize numerical information, and to extract predetermined keywords from text information so as to generate evaluation feature information including participation task information, work time information, role information, goal achievement information, and capability characteristic information;

wherein the processor is configured to associate, based on the evaluation feature information, goal information and performance information for each evaluation target and for each work unit, to calculate goal achievement indices and work efficiency indices, and to generate internal evaluation summary information including results of the calculation;

wherein the processor is configured to convert the internal evaluation summary information into a natural-language prompt sentence and to include, in the prompt sentence, instruction information regarding evaluation viewpoints, evaluation scales, and output formats;

wherein the processor is configured to input the prompt sentence to a generative AI model included in the generative information processing unit and to cause the generative AI model to generate work performance evaluation information for the evaluation target;

wherein the processor is configured to analyze the work performance evaluation information obtained from the generative AI model, to extract summary information, strength information, improvement-required information, and comprehensive evaluation indices, and to store extracted results as evaluation result information in the storage device; and

wherein the processor is configured to transmit the evaluation result information to the user terminal and to format the evaluation result information into a form displayable on the user terminal.

### (Supplementary 2)

The system according to supplementary 1,

wherein the processor is configured to construct the prompt sentence to be input to the generative AI model such that self-evaluation information and behavior schedule information of the evaluation target, and the goal achievement indices and the work efficiency indices, are presented in a same context, and such that an instruction to evaluate consistency and discrepancy among these pieces of information is included, thereby automatically executing comparative evaluation between the self-evaluation and objective indices of the evaluation target.

### (Supplementary 3)

The system according to supplementary 1,

wherein the processor is configured to receive and store additional information and correction information from a user with respect to the evaluation result information, and to manage the additional information and the correction information in association with evaluation information generated by the generative AI model, thereby enabling generation of integrated human resource evaluation information that combines human evaluation and automatic evaluation.

### Application Example 2

### (Supplementary 1)

A system comprising a processor,

wherein the processor is configured to

acquire evaluation target information including self-evaluation information and work plan information via an input device,

generate integrated evaluation data by integrating the evaluation target information with externally acquired information,

generate a prompt sentence in a natural language based on the integrated evaluation data, input the prompt sentence as input data to a generative artificial intelligence model and obtain performance evaluation information from the generative artificial intelligence model, input text data included in the self-evaluation information or in the evaluation target information to an emotion analysis engine and obtain emotional state information,

generate evaluation result information by using the performance evaluation information and the emotional state information and store the evaluation result information in a storage device, and

present the evaluation result information to a user terminal via an output device or a communication device.

### (Supplementary 2)

The system according to supplementary 1,

wherein the processor is configured to

automatically generate the prompt sentence from the evaluation target information and the externally acquired information and to continuously execute input of the prompt sentence to the generative artificial intelligence model and acquisition of the performance evaluation information, thereby automating an evaluation process and shortening evaluation time.

### (Supplementary 3)

The system according to supplementary 1,

wherein the processor is configured to

organize, as the integrated evaluation data, at least project information, time information, subject characteristic information, equipment operation information, and environment information, and to perform a comprehensive work efficiency evaluation by calculating efficiency and contribution of a subject or a device in multiple aspects based on the performance evaluation information and the emotional state information.

What is claimed is:

1. A system comprising:
circuitry configured to:
receive, via a communication interface coupled to a packet-switched network, self-evaluation information of a subject from a terminal device, store the self-evaluation information in a storage device, and receive work plan information of the subject from an internal processing device or information storage device via the communication interface;
generate a prompt sentence incorporating the self-evaluation information, input the prompt sentence to a generative AI model to extract evaluation features, organize project information, work time information, and characteristic information of the subject, and store the extracted evaluation features in the storage device; and
identify an emotional state of the subject using an emotion analysis engine based on data received from the terminal device via the communication interface, adjust an evaluation result based on the identified emotional state, and transmit the evaluation result to the terminal device via the communication interface.

2. The system according to claim 1, wherein the circuitry is configured to receive self-evaluation information of a subject from the terminal device via the communication interface, and store the self-evaluation information in the storage device as natural language text.

3. The system according to claim 2, wherein the circuitry is configured to generate a prompt sentence incorporating the natural language text of the self-evaluation information, request analysis by the generative AI model using the prompt sentence, and extract evaluation features including at least project information, work time information, and characteristic information of the subject from the analysis result.

4. The system according to claim 3, wherein the circuitry is configured to receive work plan information of the subject from an internal processing device via the communication interface, normalize the work plan information, and store the normalized work plan information in the storage device as work unit information.

5. The system according to claim 4, wherein the circuitry is configured to generate a second prompt sentence incorporating the extracted evaluation features and the normalized work plan information, input the second prompt sentence to the generative AI model to generate a structured evaluation result, and store the evaluation result in the storage device.

6. The system according to claim 5, wherein the circuitry is configured to identify the emotional state of the subject by applying the emotion analysis engine to at least one of voice data, facial expression data, and text data received from the terminal device via the communication interface.

7. The system according to claim 6, wherein the circuitry is configured to adjust at least one of a score weighting, a feedback tone, and a content emphasis of the evaluation result based on the identified emotional state of the subject.

8. The system according to claim 1, wherein the circuitry is configured to automate evaluation of work efficiency of the subject by comparing work time information against project milestones extracted from the work plan information, and incorporate the efficiency analysis into the evaluation result.

9. The system according to claim 8, wherein the circuitry is configured to detect discrepancies between self-evaluation information and work time data derived from the work plan information, and generate a prompt sentence for the generative AI model to reconcile the discrepancies in the evaluation result.

10. The system according to claim 1, wherein the circuitry is configured to receive self-evaluation information from a plurality of subjects via the communication interface, aggregate the evaluation features extracted for each subject, and generate organization-level performance data by inputting an aggregation prompt to the generative AI model.

11. The system according to claim 10, wherein the circuitry is configured to transmit organization-level performance data to a supervisory terminal device via the communication interface, and update the storage device with the aggregated performance data.

12. The system according to claim 1, wherein the circuitry is configured to receive feedback on the transmitted evaluation result from the terminal device via the communication interface, incorporate the feedback into the storage device, and adjust evaluation feature extraction parameters for subsequent evaluations.

13. The system according to claim 12, wherein the circuitry is configured to store a record of evaluation results and associated feedback in the storage device, and use the stored records to improve the prompt sentences generated for the generative AI model in subsequent evaluations.

14. The system according to claim 1, wherein the circuitry is configured to generate a prompt sentence incorporating characteristic information of the subject extracted by the generative AI model, request from the generative AI model a recommendation for skill development or workload adjustment, and incorporate the recommendation into the evaluation result.

15. The system according to claim 14, wherein the circuitry is configured to transmit the skill development or workload adjustment recommendation to the terminal device via the communication interface, and store the recommendation in the storage device in association with the subject identifier.

16. The system according to claim 1, wherein the circuitry is configured to monitor changes in the evaluation features stored in the storage device over successive evaluation periods, and generate a prompt sentence for the generative AI model to analyze trends in the evaluation features.

17. The system according to claim 16, wherein the circuitry is configured to transmit a trend analysis generated by the generative AI model to the terminal device, and incorporate the trend analysis into a long-term performance profile stored in the storage device.

18. A system comprising:
circuitry configured to:
receive, via a communication interface coupled to a packet-switched network, self-evaluation information and work plan information of a subject from a terminal device and an internal processing device, and store the information in a storage device;
generate a prompt sentence incorporating the self-evaluation information, input the prompt sentence to a generative AI model to extract evaluation features including project information, work time information, and characteristic information, and generate a structured evaluation result;
identify an emotional state of the subject using an emotion analysis engine, and adjust the evaluation result based on the identified emotional state; and
transmit the evaluation result to the terminal device via the communication interface, and update the storage device based on feedback received from the terminal device.

19. The system according to claim 18, wherein the circuitry is configured to receive self-evaluation information from a plurality of subjects via the communication interface, aggregate the evaluation features extracted for each subject, and generate organization-level performance data for transmission to a supervisory terminal device.

20. A method comprising:
receiving, via a communication interface coupled to a packet-switched network, self-evaluation information of a subject from a terminal device and work plan information from an internal processing device, storing the information in a storage device, and generating a prompt sentence incorporating the self-evaluation information;
inputting the prompt sentence to a generative AI model to extract evaluation features including project information, work time information, and characteristic information, and generating a structured evaluation result; and
identifying an emotional state of the subject using an emotion analysis engine, adjusting the evaluation result based on the identified emotional state, and transmitting the evaluation result to the terminal device via the communication interface.
